(19) United States
(12) Patent Application Publication
(10) Pub. No.: US 2021/0125129 A1
(43) Pub. Date: Apr. 29, 2021

(54) METHODS AND SYSTEM FOR GENERATING AT LEAST ONE UTILITY FINGERPRINT ASSOCIATED WITH AT LEAST ONE PREMISES

(71) Applicants: Martha Patricia Vega, Houston, TX (US); Paul Solano, The Woodlands, TX (US); Ed Marotta, Houston, TX (US); Alberto Rivas, Spring, TX (US); Yavuz Kadioglu, The Woodlands, TX (US); Vishwas Bongirwar, Alpharetta, GA (US)

(72) Inventors: Martha Patricia Vega, Houston, TX (US); Paul Solano, The Woodlands, TX (US); Ed Marotta, Houston, TX (US); Alberto Rivas, Spring, TX (US); Yavuz Kadioglu, The Woodlands, TX (US); Vishwas Bongirwar, Alpharetta, GA (US)

(21) Appl. No.: 17/084,599

(22) Filed: Oct. 29, 2020

Related U.S. Application Data
(60) Provisional application No. 62/927,363, filed on Oct. 29, 2019.

(51) Int. Cl. G06Q 10/06; G06Q 50/06; H02J 3/00

(52) U.S. Cl. CPC G06Q 10/06315; H02J 3/003; G06Q 50/06

(57) ABSTRACT

A system for generating at least one utility fingerprint associated with at least one premises is provided. The system includes a communication device, a processing device and a storage device. The communication device is configured for receiving utility consumption information from at least one utility consumption information source, receiving premises information from at least one premises information source, receiving lifestyle information from at least one lifestyle information source and transmitting at least one utility fingerprint to an electronic device. The processing device is configured for analyzing each of the utility consumption information, the premises information and the lifestyle information and generating the at least one utility fingerprint associated with the at least one premises based on the analyzing. The storage device is configured for storing each of the utility consumption information, the premises information, the lifestyle information and the at least one utility fingerprint.

The current application claims a priority to the U.S. provisional patent application Ser. No. 62/927,363 filed on Oct. 29, 2019.

### FIELD OF THE INVENTION

Generally, the present disclosure relates to the field of data processing. More specifically, the present disclosure relates to methods and system for generating at least one utility fingerprint associated with at least one premises.

### BACKGROUND OF THE INVENTION

Monitoring, minimizing and managing energy consumption are needed in order to provide for a sustainable, eco-friendly energy infrastructure currently and in the future. Energy security and independence depends not only on finding and securing new sources of energy but also on finding more efficient ways to utilize existing resources, and providing the tools for the civil society, including end-users of energy, to understand and optimize their usage and its impact.

The energy landscape is undergoing a complete transformation. Over the next few years, consumers will have immediate access to more energy choices than ever before. Innovations in technology combined with the emergence of a truly distributed, renewably-powered grid and the electrification of vehicles will put increasingly more choices, power and challenges into consumers' hands.

However, utilities often find themselves ill-equipped to deepen and evolve relationships with consumers, optimize integration of distributed resources, and be responsive business model transformations. Further, conventional systems are not easy to use for analyzing energy consumption. Therefore, there is a need for improved methods and system for generating at least one utility fingerprint associated with at least one premises that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed is a system for generating at least one utility fingerprint associated with at least one premises. The system may include a communication device, a processing device and a storage device. Further, the communication device may be configured for receiving at least one utility consumption information from at least one utility consumption information source. Further, the at least one utility consumption information may be associated with consumption of at least one utility corresponding to the at least one premises. Further, the communication device may be configured for receiving at least one premises information from at least one premises information source Further, the at least one premises information may be associated with the at least one premises. Further, the communication device may be configured for receiving at least one lifestyle information from at least one lifestyle information source Further, the at least one lifestyle information may be associated with at least one occupant of the at least one premises. Further, the communication device may be configured for transmitting at least one utility fingerprint associated with the at least one premises to at least one electronic device. Further, the processing device may be configured for analyzing each of the at least one utility consumption information, the at least one premises information and the at least one lifestyle information. Further, the processing device may be configured for generating the at least one utility fingerprint associated with the at least one premises based on the analyzing. Further, the storage device may be configured for storing each of the at least one utility consumption information, the at least one premises information, the at least one lifestyle information and the at least one utility fingerprint.

According to some embodiments, a method of generating at least one utility fingerprint associated with at least one premises is disclosed. The method may include receiving, using a communication device, at least one utility consumption information from at least one utility consumption information source. Further, the at least one utility consumption information may be associated with consumption of at least one utility corresponding to the at least one premises. Further, the method may include receiving, using the communication device, at least one premises information from at least one premises information source. Further, the at least one premises information may be associated with the at least one premises. Further, the method may include receiving, using the communication device, at least one lifestyle information from at least one lifestyle information source. Further, the at least one lifestyle information may be associated with at least one occupant of the at least one premises. Further, the method may include analyzing, using a processing device, each of the at least one utility consumption information, the at least one premises information and the at least one lifestyle information. Further, the method may include generating, using the processing device, the at least one utility fingerprint associated with the at least one premises based on the analyzing. Further, the method may include transmitting, using the communication device, the at least one utility fingerprint associated with the at least one premises to at least one electronic device. Further, the method may include storing, using a storage device, each of the at least one utility consumption information, the at least one premises information, the at least one lifestyle information and the at least one utility fingerprint.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a block diagram of a system for generating at least one utility fingerprint associated with at least one premises, in accordance with some embodiments.

FIG. 2 is a flowchart of a method for generating at least one utility fingerprint associated with at least one premises, in accordance with some embodiments.

FIG. 3 is a flowchart of a method for obtaining a reference premises information and a reference utility consumption information, in accordance with some embodiments.

FIG. 4 is a flowchart of a method for obtaining at least one environment conditioning utility consumption information, in accordance with some embodiments.

FIG. 5 is a flowchart of a method for obtaining determining at least one non-usage period and a utility leakage, in accordance with some embodiments.

FIG. 6 is a flowchart of a method for obtaining a utility consumption variation and a lifestyle variation, in accordance with some embodiments.

FIG. 7 is a block diagram of a system for performing end-use analytics and optimization of energy consumption, in accordance with some embodiments.

FIG. 8 is a flow diagram of a method to receive and analyze the various data from a plurality of databases, in accordance with some embodiments.

FIG. 9 is a flow diagram of a method to receive and analyze the various data from the plurality of databases, in accordance with some embodiments.

FIG. 10 is a schematic of a user interface for user communications with the system, in accordance with some embodiments.

FIG. 11 is a schematic of a user interface for user communications with the system, in accordance with some embodiments.

FIG. 12 is a schematic of a user interface for user communications with the system, in accordance with some embodiments.

FIG. 13 is a schematic of a user interface for user communications with the system, in accordance with some embodiments.

FIG. 14 is a schematic of a user interface for system communications with the user, in accordance with some embodiments.

FIG. 15 is a schematic of a user interface for system communications with the user, in accordance with some embodiments.

FIG. 16 is a schematic of a user interface for system communications with the user, in accordance with some embodiments.

FIG. 17 is a schematic of a user interface for system communications with the user, in accordance with some embodiments.

FIG. 18 is a schematic of a user interface for system communications with the user, in accordance with some embodiments.

FIG. 19 depicts a historical baseline from the historical previous usage data, in accordance with some embodiments.

FIG. 20 depicts July temperatures for Houston.

FIG. 21 depicts average monthly temperatures along with average monthly consumption, in accordance with some embodiments.

FIG. 22 is a flow diagram for calculating lighting usage, in accordance with some embodiments.

FIG. 23 is a flow diagram depicting additional details of the flow diagram of FIG. 22.

FIG. 24 is a flow diagram for calculating lighting usage, in accordance with some embodiments.

FIG. 25 is a user interface for system communications with the user regarding energy leakage, in accordance with some embodiments.

FIG. 26 is a user interface for system communications with the user regarding a portion of results from the system, in accordance with some embodiments.

FIG. 27 is a block diagram showing of inputs and outputs for an analytics engine, in accordance with some embodiments.

FIG. 28 is a flow diagram of a method for generating personalized data related to energy consumption, in accordance with some embodiments.

FIG. 29 is a user interface generated by the system for electricity consumption trends.

FIG. 30 is a user interface generated by the system for the leaks and impact of electricity consumption.

FIG. 31 is a user interface generated by the system for the leaks and impact of electricity consumption.

FIG. 32 is a user interface displaying consumption usage vs. projected predictions metrics of the present disclosure.

FIG. 33 is an illustration of an online platform consistent with various embodiments of the present disclosure.

FIG. 34 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of generating at least one utility fingerprint associated with at least one premises, embodiments of the present disclosure are not limited to use only in this context.

### Overview

According to some embodiments, the present disclosure provides systems and methods for analyzing and optimizing power consumption by a customer or user (e.g., both consumers and businesses) using a processor, a communication interface coupled to the processor, and a memory coupled to the processor, where the communication interface may be used to retrieve data for and related to energy consumption and related data impacting that consumption, and the memory may contain energy analysis logic that is executed by the processor to create an energy analysis system that communicates to obtain and analyze energy usage data, other dynamic data related to energy usage, and dynamic user information related to the user's consumption of energy, and where the results of the analysis may be ranked for further review and action by a user.

According to some embodiments, the present disclosure provides systems and methods for facilitating an adaptive data-driven and behavioral-driven analytics and optimization for end-use energy consumption.

Further, aspects of the present disclosure relate to methods and a system for statistically analyzing and optimizing power consumption by a customer or user (e.g., both consumers and businesses). This disclosure relates to obtaining and analyzing power consumption, and also relates to using the results of that analysis for reducing and optimizing energy use and its associated carbon footprint.

While most people want to save energy and money, no two consumers are the same. Personal preferences, lifestyles and energy aspirations are unique. Individual energy consumption depends on multiple factors that change constantly over time.

To account for these dynamics, the present disclosure provides a control system using technology to integrate personalized, historical energy consumption data with locational information, building characteristics, lifestyle behaviors, and preferences to create a unique Energy FingerPrint for each customer. This system allows consumers to see and truly understand their energy habits for the first time ever and provides a more accurate digital representation (Building Digital Twin) for energy providers to utilize in analytics, energy optimization, systems planning and energy arbitrage. The method described in this disclosure addresses these issues with a distinctive, holistic approach. The method uses cross-pollinating lessons learned across energy sectors and integrating digital and energy technology with behavioral science. The present disclosure also addresses these issues to help energy providers and consumers alike to realize the full potential of the transition towards more decentralized, decarbonized and increasingly digital energy systems.

A computer implemented energy analysis system of the present disclosure uses a processor, a communication interface coupled to the processor, and a memory coupled to the processor. The communication interface may be used to retrieve data for and related to energy consumption and related data impacting that consumption. The memory may contain energy analysis logic that is executed by the processor to create an energy analysis system that communicates to obtain and analyze energy usage data, other dynamic data related to energy usage, and dynamic user information related to the user's consumption of energy. The results of the analysis may be ranked for further review and action by a user.

The energy analysis system of the present disclosure provides direct integration and linkage of customer historical energy usage data, lifestyle schedules, preferences, and settings through advanced data science and simplified pragmatic methods to identify non-intrusive ways to save energy without requiring efforts by the customer to change the regular activities in which electricity is actively consumed in a household. This integration of a plurality of customer inputs, data and behavioral science brings visibility to previously unknown wasted electricity, quantify its associated cost and environmental impact, and equally importantly provides a non-intrusive way to save energy.

The energy analysis system of the present disclosure uses a multidimensional model comprised of the integration of a plurality of different functions that varying over time, that include electricity consumptions variation over time, lifestyle behavior variations over time (e.g., schedules, occupants), preferences variations overtime (e.g., space cooling and heating set points, water heater temperature, cost reduction, environmental footprint reduction, etc.), building feature efficiency variations over time (e.g., new A/C, new led lights, aging appliance, broken air sealing barriers, maintenance, etc.), and outdoor temperature variations over time that are location specific.

The present disclosure provides an embodiment for a control system for end-user energy analytics and optimization, using a processor, a first memory for storing programming instructions for the processor, wherein a first set of instructions when executed by the processor cause the processor to receive, convert and store in a single common interoperable data format preselected data from multiple sources regarding a plurality of customer premises, and wherein a second set of instructions when executed by the processor cause the processor to partition historical data, aggregate, compare and analyze said data using at least common time period and time slice information for each premises of the plurality, a second memory for separately storing the preselected data from multiple sources that comprises historical energy usage data for a plurality of customer premises at a plurality of preselected locations for a premises, historical weather data for preselected locations, data for a plurality of customer premises at preselected locations, and user preference and schedule data for respective premises in the plurality of customer premises, and a user interface for displaying results in one of a plurality of preselected formats from said processor processing said preselected data and analysis of the preselected data stored in said memories and from comparisons and combinations of those sets of data in at least common time periods, wherein the results comprise at least one of the following: comparisons of energy usage in the same time period during different times, comparisons of energy usage in adjacent time periods, alternative representations of energy consumption for a preselected time period, energy consumption for preselected energy consumption devices for a preselected time period, determination of unintended energy consumption, efficiency of energy consumption, comparisons of energy usage for similar residences at the preselected location for preselected time periods, recommendations for reduction in energy consumption, and recommendations for adjustment in preference and schedule data for a user to control and reduce energy usage and environmental impact.

The present disclosure provides an embodiment for a control system for end-user energy analytics and optimization, using at least one processor and an associated instruction memory containing energy analysis logic for execution by said at least one processor, wherein said energy analysis logic generates a multidimensional model comprised of the storage, analysis, integration and time alignment of historical electricity consumption for a premises, user lifestyle behavior variations for a premises, user preference variations for a premises, building feature efficiency variations for a premises, weather variations at a specific location where a premises is located, and outdoor temperature variations at that specific location, at least one memory storage device configured to store, at least said multidimensional model, intermediary calculations, analysis and comparisons and data for an end-user premises, historical weather and temperatures for said premises location, historical energy usage, end-user preferences, end-user lifestyle information and schedules, and a graphical user interface for selectively displaying representations of portions of said multidimensional model to a user in user selected formats for recommendations for adjustment in preference and schedule data for a user to reduce energy usage and environmental impact.

The present disclosure provides an embodiment for a control system for end-user energy analytics and optimization for a user premises, consisting of at least one processor and an associated instruction memory, for storing, using and analyzing data from a database configured to store historical weather and temperatures, a database configured to store historical energy usage, a database configured to store location data, a database configured to store end-user preferences, a database configured to store end-user lifestyle information and schedules, and a database configured to store end-user premises information, to perform analysis of said data from said databases to construct a multidimensional energy model representative of said analysis of said data in said databases for the user premises, and a graphical user interface for selectively displaying representations of portions of said multidimensional model to a user in user selected formats for recommendations for adjustment in preference and schedule data for a user to reduce energy usage and environmental impact.

The present disclosure provides an embodiment of an energy analysis control system, consisting of a processor, a communication interface coupled to the processor, and a memory coupled to the processor, wherein the memory contains energy analysis logic that is executed by the processor to create an energy analysis system, wherein said energy analysis system communicates to obtain energy usage data, other dynamic data related to energy usage by a user premises, and dynamic user information related to the user's consumption of energy at a premises in order to produce personalized analysis results as a multidimensional energy model representative of said analysis of said data for a premises, and generate and display on a user interface selective portions of the analysis results, and wherein said results of the analysis may be ranked for further review and action by the user using a graphical user interface for selectively displaying representations of portions of said multidimensional model to a user in user selected formats for recommendations for adjustment in preference and schedule data for a user to reduce energy usage and environmental impact. The present disclosure provides an embodiment of a control system for end-user energy analytics and optimization, using at least one processor and an associated instruction memory, at least one memory storage device configured to store: historical energy usage data for a premises, historical weather data for the location associated with a premises, data for unique and variable premises energy characteristics, data regarding user selected energy goals for said premises, data regarding said premises provided by the end-user: an analytics and computation engine executed by said at least one processor using a first portion of programming instructions stored in said associated instruction memory for performing: statistical analysis of, aggregation of and disaggregation of said historical energy usage data, statistical analysis of historical weather data associated with historical energy usage data, machine learning and employing artificial intelligence models to identify data clustering, outliers and other data driven insights and provide feedback and input to selected portions of and types of analysis, conditioning, conversion of and storage of said historical energy usage data, time slice synchronization of selected portions of said data stored in said at least one memory storage device, analyzing said data for energy consumption by one or more energy devices associated with said premises, computation of energy costs using said converted and stored historical energy usage data, providing alternative representations of energy usage data associated with a source of energy for said premises, determining/providing recommendations for available energy reduction choices; a display engine executed by said at least one processor using a second portion of programming instructions stored in said associated instruction memory for generating a graphical user interface for: receiving end-user goals, criteria for energy consumption plans and premises occupation data, displaying synchronized time slice data in one or more pre-selected formats, displaying alternative representations of energy usage data associated with a source of energy for said premises, displaying alternative representations of environmental impact associated with the energy consumption and the source of energy for said premises, displaying recommendations for available energy reduction choices, displaying recommendations and alternative representations for available environmental impact reduction choices, displaying energy consumption for said energy devices associated with said premises, and displaying and alerting an end-user of variances in energy use based on one or more of selected set points, excessive usage, and unintentional usage.

The present disclosure provides an embodiment of a system for determining end-user energy leakage in a residence, consisting of a memory for storing a set of data for historical energy usage data, a set of data for historical weather data, and a set of user provided data for residence information, a memory for storing a set of data for user preference and schedule data, a processor, a memory for storing instructions for the processor such that when said instructions are executed by the processor cause the processor to partition the historical sets of data into a preselected database format, calculate energy usage for time periods determined from user preference and schedule data and historical weather data, aggregate, process and analyze data using at least common time slice information, and employing machine learning models to calculate and determine away and idle energy consumption, and a user interface for displaying results in a plurality of preselected formats from said processor processing said data and analysis of the sets of data stored in said memories and from comparisons and combinations of these sets of data.

The present disclosure provides an embodiment for a method of determining end-user energy leakage consisting of storing in at least one memory storage device, at least one or more of the following: historical energy usage data for a premise, historical weather data for the area (zone) associated with said premises, data for unique and variable premises energy characteristics, data regarding selected energy goals for said premises; and end-user provided data regarding said premises, the occupants schedules that might reflect or serve to infer idle times using a first portion of programming instructions stored in an instruction memory for implementing an analytics and computation engine for performing at least one or more of the following: receiving and performing statistical analysis of, aggregation of and disaggregation of said historical energy usage data, converting and storing said historical energy usage data, statistically analyzing historical weather data associated with historical energy usage data and user, to identify data trends, correlations, clustering, outliers and other data driven insights and incorporating ongoing feedback to the analysis of said historical energy usage data accounting for locational and weather factors using time period and time slice information, synchronizing selected portions of said data stored in said at least one memory storage device using common time slice information, analyzing said data for energy consumption during away, idle and non-idle periods associated with said premises, computing energy leakage, its associated cost and environmental impact, using said converted and stored historical energy usage data comparing the energy usage of said premise during idle and away periods, providing alternative representations of energy usage during away, idle, non-idle periods, and energy leakage data associated with a source of energy for said premises, providing alternative representations of the associated cost and environmental impact of the energy usage during away, idle, non-idle periods, and energy leakage data associated with said premises, providing recommendations for available energy leakage reduction choices, and using a second portion of instructions stored in said instruction memory for displaying and performing one or more of the following: receiving end-user inputs, premises features and occupation data, displaying synchronized time slice data in one or more pre-selected formats, displaying alternative representations of energy usage and energy leak, cost and environmental impact data associated with a source of energy for said premises, displaying recommendations for available energy leakage reduction choices for example adjustment of set points and appliances operating schedules during away and idle times for said premises.

The present disclosure provides an embodiment for a platform for determining consumption of energy by equipment and appliances in a user residence using a memory for storing a set of data for historical energy usage data, a set of data for historical weather data, a set of data for statistical energy consumption data for residence equipment and appliances, and a set of user provided data for a residence information data, a memory for storing a set of data for user preference and schedule data, a processor, a memory for storing programming instructions for the processor such that when said instructions are executed by the processor cause the processor to partition the historical sets of data into a preselected database format, calculate energy usage for time periods determined from user preference and schedule data and historical weather data, aggregate, process and analyze historical and statistical data using at least common time slice information, and a user interface for displaying results in a plurality of preselected formats from said processor processing said data and analysis of the sets of data stored in said memories and from comparisons and combinations of these sets of data to provide resulting energy consumption for individual appliances and equipment in the user residence.

The present disclosure provides an embodiment of a method for determining consumption of energy by equipment and appliances in a user residence consisting of storing in at least one memory storage device, at least one or more of the following: historical (e.g., time series) energy usage data for a premise (facility), historical (e.g., time series) time series weather data for the area (zone) associated with said premises (facility), data for unique and variable premises energy characteristics; and end-user provided data regarding said premises, the number of occupants, the occupants preferred indoor cooling and heating temperature, and the appliances in said premise, using a first portion of instructions stored in an instruction memory for implementing an analytics and computation engine for performing at least one or more of the following: receiving and performing statistical analysis of, aggregation of and disaggregation of said historical energy usage data, converting and storing said historical energy usage data, statistically analyzing historical weather data associated with historical energy usage data and user, to identify data trends, correlations, clustering, outliers and other data driven insights and incorporating ongoing feedback to the analysis of said historical energy usage data accounting for locational and weather factors, synchronizing selected portions of said data stored in said at least one memory storage device using common time slice information, analyzing said data to determine weather neutral dates in which it is assumed that there is no need for using air-conditioning or heating to achieve the occupants desired indoor temperature associated with said premises, given the outdoor weather conditions for the location associated with said premises, analyzing said data for energy consumption during weather neutral dates associated with said premises, computing the base energy consumption load for said premise, using said converted and stored historical energy usage data, analyzing said data for energy consumption during the remaining dates in the time series associated with said premises, computing the energy consumption load for said premise, during the remaining dates in the time series (e.g., non-weather neutral dates) using said converted and stored historical energy usage data, comparing the energy usage of said premise during weather neutral dates and non-weather neutral dates to compute the energy usage associated with air-conditioning and heating for the said premise, computing the energy consumption load for lights in said premise, during the entire period in the time series (e.g., weather neutral dates and non-weather neutral dates) using said converted and stored historical physical characteristics and energy usage data for said premise, and statistical energy usage for said physical characteristics for said premise, computing the energy consumption by end appliance using statistical modeling of end-appliance building electricity consumption using said converted and stored historical physical characteristics, and energy usage data for said premise adjusted for the energy usage corresponding to air conditioning, heating and lights previously computed; and statistical energy usage for said physical characteristics for said premise, providing alternative representations of energy usage, cost and environmental impact by end use appliance associated with a source of energy for said premises, determining recommendations for available energy reduction choices, and using a second portion of instructions stored in said instruction memory for displaying and performing one or more of the following: receiving end-user inputs and updates (e.g., goals, preferences, lifestyle, appliances settings), premises features and occupation data, displaying synchronized time slice data in one or more pre-selected formats, displaying alternative representations of energy usage, cost and environmental impact data by end use appliance associated with a source of energy for said premises, displaying recommendations for available energy usage reduction choices for example adjustment of set points and appliances operating schedules during away and idle times, changes to higher energy efficiency options for said premises.

The present disclosure provides an embodiment of a method for end-user energy analytics and optimization, consisting of receiving, converting and storing in a single common interoperable data format preselected data from multiple sources in a memory, separately storing the preselected data from multiple sources wherein the data comprises: historical energy usage data for a preselected location, historical weather data for a preselected location, data for a premise at the preselected location, and user preference and schedule data for a premises, partitioning historical data, aggregating, comparing and analyzing said data using at least common time period (energy use cycles) and time slice information, and displaying in a plurality of preselected formats results from said partitioned, aggregated, compared and analyzed stored data, wherein the results comprise at least one of the following: comparing energy usage in the same time period during different times, comparing energy usage in adjacent time periods, representing energy consumption for a preselected time period in an alternative format, calculating energy for preselected energy consumption devices for a preselected time period, determining unintended energy consumption, determining efficiency of energy consumption, comparing energy usage for similar residences at the preselected location for preselected time periods, and recommending energy consumption reductions.

The present disclosure provides an embodiment of a method for end-user energy analytics and optimization, consisting of receiving, converting and storing in a single common interoperable data format preselected data from multiple sources in a memory, separately storing the preselected data from multiple sources wherein the data comprises: historical energy usage data for a preselected location, historical weather data for a preselected location, data for a premises at the preselected location, and user preference and schedule data for a premises, using a processor having instructions stored in an instruction memory for the processor, wherein a first set of instructions when executed by the processor cause the processor to partition historical data, aggregate, compare and analyze said data using at least common time period (energy use cycles) and time slice information, and displaying results in a user interface in a plurality of preselected formats from said processor processing said preselected data and analysis of the preselected data stored in said memories and from comparisons and combinations of those sets of data in common time periods, wherein the results comprise at least one of the following: comparisons of energy usage in the same time period during different times, comparisons of energy usage in adjacent time periods, alternative representations of energy consumption for a preselected time period, energy consumption for preselected energy consumption devices for a preselected time period, determination of unintended energy consumption, efficiency of energy consumption, comparisons of energy usage for similar residences at the preselected location for preselected time periods, and recommendations for reduction in energy consumption.

The present disclosure provides an embodiment of a computer implemented method, consisting of (i) storing in at least one memory storage device, at least one or more of the following: historical energy usage data for a premises (facility), historical weather data for the area (zone) associated with said premises (facility), data for unique and variable premises energy characteristics, data regarding selected energy goals for said premises, and end-user provided data regarding said premises, (ii) using at least one processor having instructions stored in at least one instruction memory, wherein said at least one processor is configured to implement an analytics and computation engine using a first portion of programming instructions stored in said associated instruction memory for performing at least one or more of the following: receiving and performing statistical analysis of, aggregation of and disaggregation of said historical energy usage data, statistically analyzing historical weather data associated with historical energy usage data, using machine learning and employing artificial intelligence models to identify data clustering, outliers and other data driven insights and incorporate ongoing feedback to the analysis of said historical energy usage data, converting and storing said historical energy usage data, synchronizing selected portions of said data stored in said at least one memory storage device using common time slice information, analyzing said data for energy consumption by one or more energy devices associated with said premises, computing energy costs using said converted and stored historical energy usage data, providing alternative representations of energy usage data associated with a source of energy for said premises, determining recommendations for available energy reduction choices, and (iii) using said at least one processor to execute a display engine using a second portion of programming instructions stored in said associated instruction memory for displaying and performing one or more of the following in a user graphical interface: establishing interface with end-user (e.g., interactive), receiving end-user inputs (e.g., lifestyle, schedules, preferences, appliances set points, energy, environmental and costs goals), criteria for energy consumption plans and premises occupation data, displaying synchronized time slice data in one or more pre-selected formats, displaying alternative representations of energy usage data associated with a source of energy for said premises, displaying recommendations for available energy reduction choices, displaying energy consumption for said energy devices associated with said premises, displaying and alerting an end-user of variances in energy use based on one or more of selected set points, excessive usage, and unintentional usage; prompting for at least one of questions regarding behavioral cues, reports, comparisons versus trends, norms, or peers, and receiving end-user feedback related to changes to inputs or premises. The present disclosure provides an embodiment for a computer implemented method, consisting of storing in at least one memory storage device, at least one or more of the following: historical energy usage data for a premises (facility), historical weather data for the area (zone) associated with said premises (facility), data for unique and variable premises energy characteristics, data regarding selected energy goals for said premises, and end-user provided data regarding said premises, using a first portion of instructions stored in an instruction memory for implementing an analytics and computation engine for performing at least one or more of the following: receiving and performing statistical analysis of, aggregation of and disaggregation of said historical energy usage data, converting and storing said historical energy usage data, statistically analyzing historical weather data associated with historical energy usage data, using machine learning and employing artificial intelligence models to identify data trends, correlations, clustering, outliers and other data driven insights and incorporating ongoing feedback to the analysis of said historical energy usage data, synchronizing selected portions of said data stored in said at least one memory storage device using common time slice information, analyzing said data for energy consumption by one or more energy devices associated with said premises, computing energy costs using said converted and stored historical energy usage data, providing alternative representations of energy usage data associated with a source of energy for said premises, determining/providing recommendations for available energy reduction choices, and using a second portion of instructions stored in said instruction memory for displaying and performing one or more of the following: receiving end-user inputs (e.g., goals, preferences, lifestyle, appliances settings), premises features and occupation data, displaying synchronized time slice data in one or more pre-selected formats, displaying alternative representations of energy usage data associated with a source of energy for said premises, displaying recommendations for available energy reduction choices, displaying energy consumption for said energy devices associated with said premises.

The present disclosure provides an embodiment of a method for analyzing and optimization energy consumption for premises of an end-user, embodiment for a computer implemented method, consisting of statistically analyzing historical energy usage data using aggregation and disaggregation methods, statistically analyzing historical weather data associated with historical energy usage data, using machine learning and artificial intelligence models to identify data clustering, outliers and other data driven insights and incorporate ongoing feedback to the analysis, converting and storing said historical energy usage data in at least one memory storage device and computing energy costs using said converted and stored historical energy usage data, synchronizing selected portions of said data stored in said at least one memory storage device using a common time slice, analyzing said historical energy usage data for energy consumption by one or more energy devices associated with said premises, providing alternative representations of energy usage data associated with a source of energy for a premise having said historical energy usage data, determining/providing recommendations for available energy reduction choices, receiving end-user inputs (e.g., goals, criteria for energy consumption plans, premises features, and occupation data), displaying synchronized time slice data in one or more pre-selected formats, displaying alternative representations of energy usage data associated with a source of energy for said premises, displaying alternative representations of environmental impact associated with the energy consumption and the source of energy for said premises, displaying recommendations and alternative representations for available environmental impact reduction choices, displaying recommendations for choices for available energy reduction, displaying energy consumption for energy devices associated with said premises, displaying and alerting an end-user of variances in energy use based on one or more of selected set points, excessive usage, and unintentional usage.

The present disclosure provides a system for energy analysis that may be implemented using a wide variety and range of technologies, for example, but not limited to web based, cloud, IoT devices, and traditional digital computing devices, or non-traditional computing edge devices. In one embodiment the system may include data and information collection and integration, data analysis and comparisons, data disaggregation and aggregation, summaries of analysis, generate alerts, reports, and recommended or corrective actions to form a control system. After initialization and analysis, the system may be used to provide continuous or periodic monitoring and continue to recommend options to optimize energy consumption. As used herein “customer”, “consumer”, “end-user”, “occupant” and “user” may be used interchangeably, similarly for “premises”, “residence”, “structure”, “building” and “dwelling”, they may also be used interchangeably.

Further, the present disclosure teaches creating a unique customer multidimensional energy profile (Energy FingerPrint) that integrates household lifestyle activities and user preferences to create a multidimensional envelope providing a more accurate model (e.g., digital twin) of the user's consumption based on a user's premises and its devices, and the user's priorities, behaviors, and activities. Further, the present disclosure teaches storing in a single common interoperable data format preselected data received from multiple sources regarding a plurality of customer premises. Further, the present disclosure teaches ranking the results of the analysis of power consumption by a user for further review and action by the user.

Further, the present disclosure uses a direct linkage of customer historical usage, lifestyle schedules, preferences, and settings through advanced data science and simplified pragmatic methods to identify non-intrusive ways to save energy without requiring efforts on the part of the consumer to change regular activities in which electricity is consumed in a residence, household, or premises.

Advances in cognitive computing and predictive intelligence are giving systems the ability to learn using data to adapt from experience without being explicitly programmed. This is leading to endless possibilities to extract knowledge and actionable insights from previously underutilized data, helping improve productivity, reliability and longevity. However, utilities often find themselves ill-equipped to harvest the full potential that Artificial Intelligence (AI) systems present, including the opportunity to deepen and evolve relationships with consumers, optimize integration of distributed resources, and be responsive business model transformations. Further, the present disclosure teaches an easy to use, user friendly system for analyzing energy consumption.

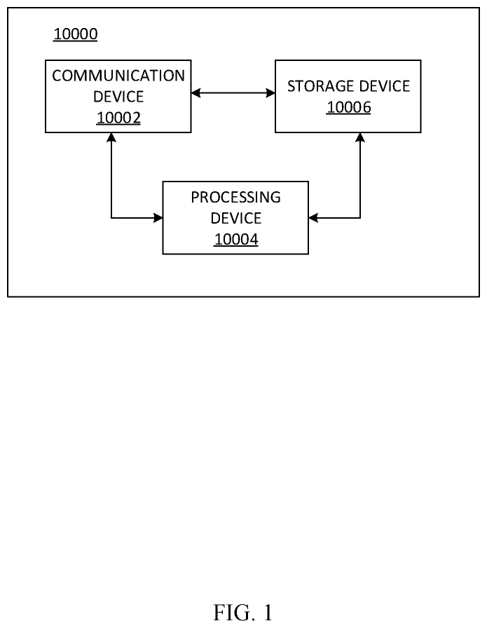

Referring now to figures, FIG. 1 is a block diagram of a system 10000 for generating at least one utility fingerprint associated with at least one premises, in accordance with some embodiments. The system 10000 may include a communication device 10002, a processing device 10004 and a storage device 10006.

The at least one utility fingerprint may be associated with consumption of at least one utility at the at least one premises. Further, in some embodiments, the at least one utility fingerprint be associated with an actual consumption of the at least one utility. In some embodiments, the at least one utility fingerprint be associated with a projected consumption of the at least one utility.

In general, the at least one utility may include any consumable that is distributable by at least one utility provider to a plurality of consumers. Examples of the at least one utility may include, but are not limited to, energy utility, such as, for example, electricity, gas, heating and cooling etc. Other such examples of the at least one utility, include, without limitation, pressurizing, de-pressurizing, humidifying, de-humidifying, sanitizing and so on.

Further, in some embodiments, the at least one utility may include a non-energy utility such as, for example, water, air, oxygen and so on. Additionally, and/or alternatively, in some embodiments, the at least one utility may include a non-energy utility including a consumable substance, such as for example, water, a biological nutrient and so on. Further, in some embodiments, the at least one utility may include a communication service, such as for example, network connectivity (e.g. Internet connectivity).

In some embodiments, the utility fingerprint may include an energy fingerprint. Further, the at least one utility may include an energy utility. In general, the energy utility may include any utility facilitating an exchange of energy between a utility provider and a consumer.

The communication device 10002 may be configured for receiving at least one utility consumption information from at least one utility consumption information source. Further, the at least one utility consumption information may be associated with consumption of at least one utility corresponding to the at least one premises.

In general, the utility consumption information may represent any information regarding consumption of the at least one utility. Further, the at least one utility consumption information source may be any source capable of supplying the at least one utility consumption information. In some embodiments, the at least utility consumption information source may include a smart utility meter configured to capture the at least one utility consumption information and transmit the at least one utility consumption information. For example, in some embodiments, the at least utility consumption information source may include a smart meter configured to measure consumption of the at least one utility (e.g. electricity, fuel, water etc.) by the at least one premises. In some embodiments, the at least one utility consumption information source may be a utility consuming appliance capable of measuring and transmitting consumption of the utility. For instance, the at least one utility consumption information source may be an IoT appliance configured to provide a corresponding functionality, while also configured to measure and transmit consumption of the utility. In some embodiments, the at least one utility consumption information source may be a database server configured to collect and provision the at least one utility consumption information. For instance, the database server may be operated by a utility provider. Further, in some embodiments, the at least one utility consumption information source may include a user device (e.g. a desktop computer, a tablet computer, a smartphone, a mobile phone, a wearable computer, etc.) configured to receive the at least one utility consumption information manually entered by a user (e.g. by way of touch inputs, voice commands, gestures etc.) and transmit the at least one utility consumption information over a network (e.g. the Internet).

Further, the communication device 10002 may be configured for receiving at least one premises information from at least one premises information source. Further, the at least one premises information may be associated with the at least one premises.

In some embodiments, the at least one premises information source may include a premises management system configured to manage the at least one premises. In an instance, the premises management system may be operated by one or more of a resident of the at least one premises, a manager of the at least one premises and an owner of the at least one premises. In some embodiments, the at least one premises information source may include a maintenance management system configured to facilitate maintenance of the at least one premises. In some embodiments, the at least one premises information source may include a user device (e.g. a desktop computer, a tablet computer, a smartphone, a mobile phone, a wearable computer, etc.) configured to receive the at least one at least one premises information manually entered by a user (e.g. by way of touch inputs, voice commands, gestures etc.) and transmit the at least one premises information over a network (e.g. the Internet). In some embodiments, the at least one premises information source may be a utility consuming appliance capable of capturing and transmitting the at least one premises information. For instance, the at least the at least one premises information source may be an IoT appliance (e.g. CCTV cameras) configured to provide a corresponding functionality (e.g. surveillance), while also configured to capture and transmit the at least one premises information. In some embodiments, the at least one premises information source may be a database server configured to collect and provision the at least one at least one premises information.

In some embodiments, the at least one premises information may include at least one of at least one location of the at least one premises, at least one environmental characteristic associated with the at least one premises, at least one structural characteristic associated with the at least one premises, at least one utility consuming appliance information associated with the at least one premises and at least one appliance information associated with the at least one premises. Further, the at least one appliance information may include appliances that do not directly consume a utility but whose presence indirectly affects consumption of utility by other utility consuming appliances.

Further, the communication device 10002 may be configured for receiving at least one lifestyle information from at least one lifestyle information source. Further, the at least one lifestyle information may be associated with at least one occupant of the at least one premises. Further, at least one lifestyle information may include user preferences and schedule information as well.

In some embodiments, the at least one lifestyle information source may include a user device (e.g. a desktop computer, a tablet computer, a smartphone, a mobile phone, a wearable computer, etc.) configured to receive the at least one at least one lifestyle information manually entered by a user (e.g. by way of touch inputs, voice commands, gestures etc.) and transmit the at least one lifestyle information over a network (e.g. the Internet). In some embodiments, the at least one lifestyle information source may be an appliance capable of capturing and transmitting the at least one lifestyle information. For instance, the at least the at least one lifestyle information source may be an IoT appliance (e.g. IoT appliance, IoT sensor, IoT camera, microphone etc.) configured to capture and transmit the at least one lifestyle information. In some embodiments, the at least one lifestyle information source may be a database server configured to collect and provision the at least one at least one lifestyle information.

In some embodiments, the at least one lifestyle information corresponds to at least one of a number of occupants associated with the at least one premises, at least one preferred setting associated with the at least one utility consuming appliance, at least one activity performable in the at least one premises by the at least one occupant and at least one-time period associated with the at least one activity. Further, the at least one activity may include a “away time” as well.

In further embodiments, the communication device 10002 may be configured for receiving at least one schedule information from a schedule information source. Further, the processing device 10004 may be configured for determining the at least one activity and the at least one-time period based on the at least one schedule information.

In some embodiments, the schedule information source may include a user device (e.g. a desktop computer, a tablet computer, a smartphone, a mobile phone, a wearable computer, etc.) configured to receive the at least one at least one schedule information manually entered by a user (e.g. by way of touch inputs, voice commands, gestures etc.) and transmit the at least one schedule information over a network (e.g. the Internet). In some embodiments, the schedule information source may include a calendar application configured to automatically transmit the at least one schedule information. In some embodiments, the at least one schedule information source may be an appliance capable of capturing and transmitting the at least one schedule information. For instance, the at least the at least one schedule information source may be an IoT appliance (e.g. IoT appliance, IoT sensor, IoT camera, microphone, etc.) configured to capture and transmit the at least one schedule information. In some embodiments, the at least one schedule information source may be a database server configured to collect and provision the at least one at least one schedule information.

Further, the communication device 10002 may be configured for transmitting at least one utility fingerprint associated with the at least one premises to at least one electronic device. Further, the at least one electronic device may include one or more of at least one user device associated with the at least one premises and at least one utility provider device associated with at least one utility provider.

In general, the at least one electronic device may be any electronic device configured to communicate with the system 10000. In some embodiments, the at least lone electronic device may include a personal user device (E.g. smartphone, desktop computer, tablet computer, wearable computer etc.) associated with one or more users such as, for example, an occupant of the at least one premises, an administrative user corresponding to the at least one premises, a manager of the at least one premises, an owner of the at least one premises and a utility administrator/manager associated with the at least one utility provider.

Further, the processing device 10004 may be configured for analyzing each of the at least one utility consumption information, the at least one premises information and the at least one lifestyle information. In some embodiments, the analyzing may include any type of data analyzing, including those based on machine learning and/or artificial intelligence.

Further, the processing device 10004 may be configured for generating the at least one utility fingerprint associated with the at least one premises based on the analyzing.

Further, the storage device 10006 may be configured for storing each of the at least one utility consumption information, the at least one premises information, the at least one lifestyle information and the at least one utility fingerprint.

In some embodiments, the at least one utility consumption information may include a first utility consumption information corresponding to a first time period and a second utility consumption information corresponding to a second time period. Further, the at least one lifestyle information may include a first lifestyle information associated with the first time period and a second lifestyle information associated with the second time period. Further, the second time period is later than the first time period. Further, the analyzing may include determining a utility consumption variation based on comparing the first utility consumption information and the second utility consumption information. Further, the analyzing may include determining a lifestyle variation based on comparing the first lifestyle information and the second lifestyle information. Further, the at least one utility fingerprint may include each of the utility consumption variation and the lifestyle variation.

In some embodiments, the first utility consumption information may include a baseline utility consumption information. In an instance, the baseline utility consumption may include a statistical indicator (such as for example, an average value, a mean value, a median value, a standard deviation value and so on) corresponding to the utility consumption information associated with the first time period.

In an instance, the first time period may include duration of 12 months (or any other duration sufficient for capturing all periodic variations (e.g. seasonal variations with regards to environmental conditions, behavioral variations with regard to the at least one lifestyle information, maintenance variations with regard to the at least one premises information and so on.) of the at least one premises. Further, the first utility consumption information may correspond to a baseline utility consumption, which may be derived, for instance, by averaging utility consumption over a period of, for example, 12 months.

In some embodiments, the at least one premises information may include at least one efficiency indicator associated with the at least one utility consuming appliance deployed in the at least one premises. Further, the at least one efficiency indicator may include a first efficiency indicator corresponding to a first time period and a second efficiency indicator corresponding to a second time period. Further, the second time period is later than the first time period. Further, the analyzing may include determining an efficiency variation based on comparing the first efficiency indicator and the second efficiency indicator. Further, the at least one utility fingerprint may include the efficiency variation.

In some embodiments, the at least one efficiency indicator may include at least one energy efficiency indicator corresponding to at least one energy consuming appliance comprised in the at least one utility consuming appliance.

Further, in some embodiments, one or more of the lifestyle variation and the efficiency variation may be a cause of the utility consumption variation.

Further, in some embodiments, the processing device 10004 may be further configured for generating at least one correctional recommendation corresponding to at least one of utility consumption variation, the lifestyle variation and the efficiency variation. Further, the at least one correctional recommendation may mitigate, at least partially, at least one of the utility consumption variation, the lifestyle variation and the efficiency variation. Further, the communication device 10002 may be further configured for transmitting the at least one correctional recommendation to the at least one electronic device.

In some embodiments, the communication device 10002 may be configured for receiving at least one environmental information from at least one environmental information source. Further, the at least one environmental information may be associated with the at least one premises.

In some embodiments, the at least one environmental information may include a first environmental information corresponding to a first time period and a second environmental information corresponding to a second time period. Further, the second time period is later than the first time period. Further, the analyzing may include determining an environmental variation based comparing the first environmental information and the second environmental information. Further, the at least one utility fingerprint may include the environmental variation.

In further embodiments, the at least one environmental information source may include a weather database.

In further embodiments, the at least one environmental information may include at least one an indoor environmental information and an outdoor environmental information.

In further embodiments, the at least one environmental information source may include at least one sensor disposed in the at least one premises. Further, the at least one sensor may be configured to generate at least one sensor data corresponding to at least one environmental variable.

In further embodiments, the at least one environmental variable may include at least one of temperature, humidity, pressure, wind, motion, sound, light, vibration, mechanical stress and pollution.

In further embodiments, the at least one premises information may include a premises identifier associated with a premises of the at least one premises. Further, the analyzing may include identifying a premises information associated with the premises. Further, the analyzing may include performing a first comparison of the premises information with a plurality of premises information. Further, the analyzing may include performing a second comparison of a lifestyle information associated with the premises with a plurality of lifestyle information. Further, the analyzing may include performing a third comparison of an environmental information associated with the premises with a plurality of environmental information. Further, the analyzing may include determining a reference premises information based on each of the first comparison, the second comparison and the third comparison. Further, the analyzing may include determining a reference utility consumption information associated with the reference premises. Further, a utility fingerprint associated with the premises may include each of the reference premises information and the reference utility consumption information.

In further embodiments, the at least one utility consumption information may correspond to at least one total utility consumption associated with at least one environment conditioning appliance and at least one non-environment conditioning appliance disposed in the at least one premises. Further, at least one environment conditioning appliance may include any type of an equipment that maintains a preferred environmental condition within/around the premises. For example, air-conditioner, heaters, humidifiers, de-humidifiers, pressure regulators etc. Further, the non-environment conditioning appliance may include any appliance which consumes utility but which do not controllably modify the indoor environment of a premises. For example, lighting, entertainment appliances etc.

Further, the analyzing may include comparing the at least one lifestyle information and an outdoor environmental information comprised in the at least one environmental information. Further, the at least one lifestyle information may include user preferences in relation to indoor environmental conditions such as temperature, pressure, humidity, noise level etc.

Further, the analyzing may include identifying at least one weather-neutral time period and at least one non-weather-neutral time period based on the comparing. Further, the analyzing may include determining at least one baseline utility consumption information associated with the at least one weather-neutral time period. Further, the analyzing may include determining at least one environment conditioning utility consumption information corresponding to consumption of the at least one utility by the at least one environment conditioning appliance based on each of the at least one total utility consumption and the at least one baseline utility consumption. Further, the at least one utility fingerprint may include the at least one environment conditioning utility consumption information.

In further embodiments, the at least one premises information may include at least one premises utility consumption model comprising at least one premises characteristic associated with a premises, at least one utility consuming appliance associated with the premises and at least one estimated utility consumption information associated with the at least one utility consuming appliance. Further, the analyzing may include determining at least one lighting utility consumption information corresponding to consumption of the at least one utility by at least one lighting appliance based on the at least one premises utility consumption model. Further, the at least one utility fingerprint may include the at least one lighting utility consumption information.

In further embodiments, the analyzing further may include determining at least one end-appliance utility consumption information associated with at least one end appliance based on each of the at least one total utility consumption, the at least one environment conditioning utility consumption information and the at least one lighting utility consumption information. Further, the at least one utility fingerprint may include the at least one end-appliance utility consumption information.

In some embodiments, the at least one utility fingerprint may include a utility leakage. Further, the analyzing may include determining at least one non-usage period based on the at least one lifestyle information. Further, the at least one lifestyle information may correspond to at least one activity performable in the at least one premises by the at least one occupant and at least one-time period associated with the at least one activity. Further, the at least one activity may include an “away time” as well.

Further, the analyzing may include determining the utility leakage corresponding to the at least one non-usage period based on a utility consumption information associated with the at least one non-usage period.

Further, the generating of the at least one utility fingerprint may include generating an environmental impact information based on at least one of the utility leakage and the at least one utility consumption information. Further, the at least one utility fingerprint may include the environmental impact information.

In some embodiments, the at least one utility fingerprint may include a utility leakage. Further, the analyzing may include determining, using the processing device 10004, at least one non-usage period associated with the at least one utility. Further, the at least one non-usage period may include a relative time period such as “night”, “Sunday” etc. Further, a utility consumption corresponding to the at least one non-usage period may be lower than a consumption threshold. The consumption threshold may be referred to as the base load. Further, the at least one non-usage period may include a first non-usage period corresponding to a first time period and a second non-usage period corresponding to a second time period. Further, the second time period is later than the first time period; and

Further, the analyzing may include determining using the processing device 10004, the utility leakage corresponding to the second non-usage period based on comparing a first utility consumption information associated with the first non-usage period and a second utility consumption information associated with the second non-usage period.

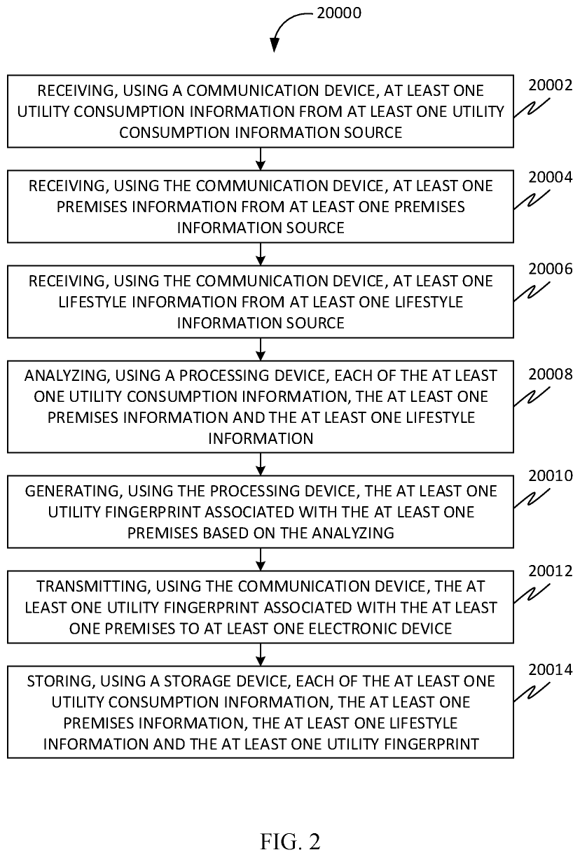

FIG. 2 is a flowchart of a method 20000 for generating at least one utility fingerprint associated with at least one premises, in accordance with some embodiments.

At 20002, the method 20000 may include receiving, using a communication device (such as the communication device 10002), at least one utility consumption information from at least one utility consumption information source. Further, the at least one utility consumption information may be associated with consumption of at least one utility corresponding to the at least one premises.

In some embodiments, the utility fingerprint may include an energy fingerprint. Further, the at least one utility may include an energy utility.

Further, at 20004, the method 20000 may include receiving, using the communication device, at least one premises information from at least one premises information source. Further, the at least one premises information may be associated with the at least one premises.

In some embodiments, the at least one premises information may include at least one of at least one location of the at least one premises, at least one environmental characteristic associated with the at least one premises, at least one structural characteristic associated with the at least one premises, at least one utility consuming appliance information associated with the at least one premises and at least one appliance information associated with the at least one premises. Further, the at least one appliance information may include appliances that do not directly consume a utility but whose presence indirectly affects consumption of utility by other utility consuming appliances.

Further, at 20006, the method 20000 may include receiving, using the communication device, at least one lifestyle information from at least one lifestyle information source. Further, the at least one lifestyle information may be associated with at least one occupant of the at least one premises.

In some embodiments, the at least one lifestyle information corresponds to at least one of a number of occupants associated with the at least one premises, at least one preferred setting associated with the at least one utility consuming appliance, at least one activity performable in the at least one premises by the at least one occupant and at least one-time period associated with the at least one activity.

In further embodiments, the communication device may be configured for receiving at least one schedule information from a schedule information source. Further, the processing device (such as the processing device 10004) may be configured for determining the at least one activity and the at least one-time period based on the at least one schedule information.

Further, at 20008, the method 20000 may include analyzing, using a processing device, each of the at least one utility consumption information, the at least one premises information and the at least one lifestyle information.

In some embodiments, the at least one premises information may include at least one efficiency indicator associated with the at least one utility consuming appliance deployed in the at least one premises. Further, the at least one efficiency indicator may include a first efficiency indicator corresponding to a first time period and a second efficiency indicator corresponding to a second time period. Further, the second time period is later than the first time period. Further, the analyzing (at 20008) may include determining an efficiency variation based on comparing the first efficiency indicator and the second efficiency indicator. Further, the at least one utility fingerprint may include the efficiency variation.

In some embodiments, the at least one efficiency indicator may include at least one energy efficiency indicator corresponding to at least one energy consuming appliance comprised in the at least one utility consuming appliance.

Further, at 20010, the method 20000 may include generating, using the processing device, the at least one utility fingerprint associated with the at least one premises based on the analyzing (at 20008).

Further, at 20012, the method 20000 may include transmitting, using the communication device, the at least one utility fingerprint associated with the at least one premises to at least one electronic device.

Further, at 20014, the method 20000 may include storing, using a storage device (such as the storage device 10006), each of the at least one utility consumption information, the at least one premises information, the at least one lifestyle information and the at least one utility fingerprint.

In some embodiments, the method 20000 may include receiving, using the communication device, at least one environmental information from at least one environmental information source. Further, the at least one environmental information may be associated with the at least one premises.

In some embodiments, the at least one environmental information may include a first environmental information corresponding to a first time period and a second environmental information corresponding to a second time period. Further, the second time period is later than the first time period. Further, the analyzing (at 20008) may include determining an environmental variation based comparing the first environmental information and the second environmental information. Further, the at least one utility fingerprint may include the environmental variation.

In further embodiments, the at least one environmental information source may include a weather database.

In further embodiments, the at least one environmental information may include at least one an indoor environmental information and an outdoor environmental information.

In further embodiments, the at least one environmental information source may include at least one sensor disposed in the at least one premises. Further, the at least one sensor may be configured to generate at least one sensor data corresponding to at least one environmental variable.

In further embodiments, the at least one environmental variable may include at least one of temperature, humidity, pressure, wind, motion, sound, light, vibration, mechanical stress and pollution.

In some embodiments, the at least one utility fingerprint may include a utility leakage. Further, the analyzing (at 20008) may include determining, using the processing device, at least one non-usage period associated with the at least one utility. Further, the at least one non-usage period may include a relative time period such as “night”, “Sunday” etc. Further, a utility consumption corresponding to the at least one non-usage period may be lower than a consumption threshold. The consumption threshold may be referred to as the base load. Further, the at least one non-usage period may include a first non-usage period corresponding to a first time period and a second non-usage period corresponding to a second time period. Further, the second time period is later than the first time period; and

Further, the analyzing (at 20008) may include determining using the processing device, the utility leakage corresponding to the second non-usage period based on comparing a first utility consumption information associated with the first non-usage period and a second utility consumption information associated with the second non-usage period.

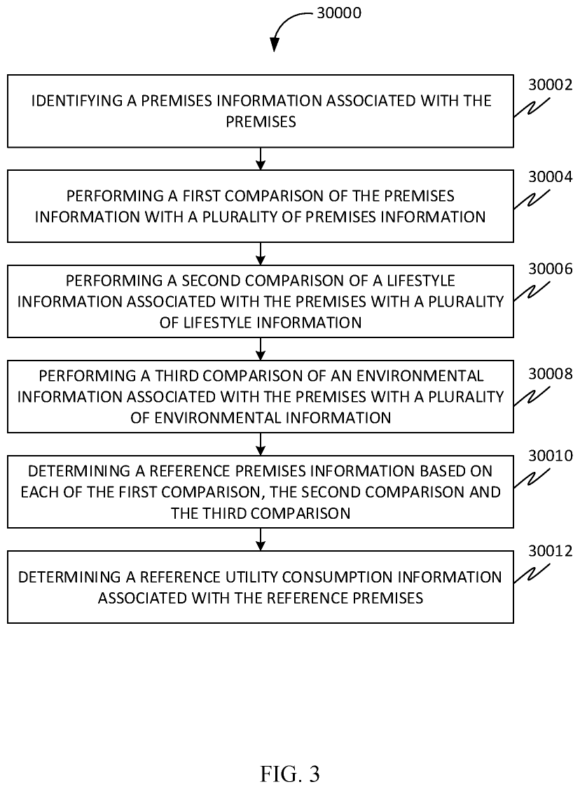

FIG. 3 is a flowchart of a method 30000 for obtaining a reference premises information and a reference utility consumption information, in accordance with some embodiments. Further, the at least one premises information may include a premises identifier associated with a premises of the at least one premises.

Further, at 30002, the method 30000 may include identifying a premises information associated with the premises. The step 30002 may be a sub-step of the analyzing step 20008 of the method 20000.

Further, at 30004, the method 30000 may include performing a first comparison of the premises information with a plurality of premises information. The step 30004 may be a sub-step of the analyzing step 20008 of the method 20000.

Further, at 30006, the method 30000 may include performing a second comparison of a lifestyle information associated with the premises with a plurality of lifestyle information. The step 30006 may be a sub-step of the analyzing step 20008 of the method 20000.

Further, at 30008, the method 30000 may include performing a third comparison of an environmental information associated with the premises with a plurality of environmental information. The step 30008 may be a sub-step of the analyzing step 20008 of the method 20000.

Further, at 30010, the method 30000 may include determining the reference premises information based on each of the first comparison, the second comparison and the third comparison. The step 30010 may be a sub-step of the analyzing step 20008 of the method 20000.

Further, at 30012, the method 30000 may include determining the reference utility consumption information associated with the reference premises. The step 30012 may be a sub-step of the analyzing step 20008 of the method 20000. Further, a utility fingerprint associated with the premises may include each of the reference premises information and the reference utility consumption information.

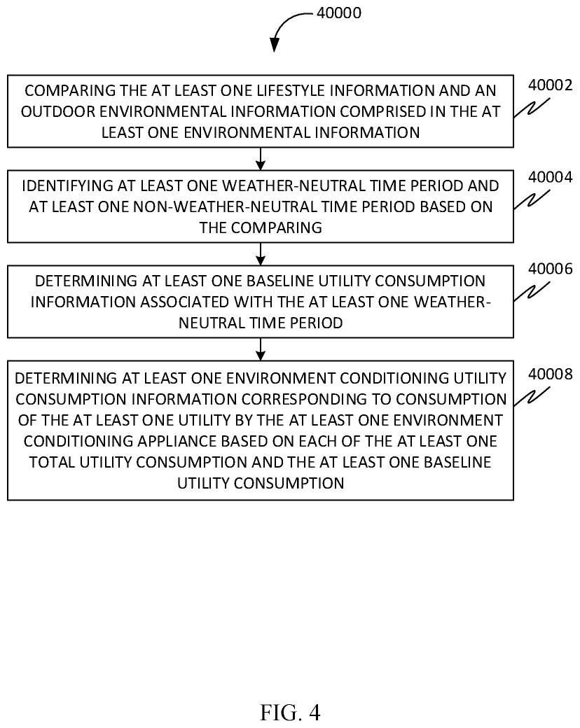

FIG. 4 is a flowchart of a method 40000 for obtaining at least one environment conditioning utility consumption information, in accordance with some embodiments. Further, the at least one utility consumption information may correspond to at least one total utility consumption associated with at least one environment conditioning appliance and at least one non-environment conditioning appliance disposed in the at least one premises.

Further, at 40002, the method 40000 may include comparing the at least one lifestyle information and an outdoor environmental information comprised in the at least one environmental information. The step 40002 may be a sub-step of the analyzing step 20008 of the method 20000.

Further, at 40004, the method 40000 may include identifying at least one weather-neutral time period and at least one non-weather-neutral time period based on the comparing. The step 40004 may be a sub-step of the analyzing step 20008 of the method 20000.

Further, at 40006, the method 40000 may include determining at least one baseline utility consumption information associated with the at least one weather-neutral time period. The step 40006 may be a sub-step of the analyzing step 20008 of the method 20000.

Further, at 40008, the method 40000 may include determining the at least one environment conditioning utility consumption information corresponding to consumption of the at least one utility by the at least one environment conditioning appliance based on each of the at least one total utility consumption and the at least one baseline utility consumption. The step 40008 may be a sub-step of the analyzing step 20008 of the method 20000. Further, the at least one utility fingerprint may include the at least one environment conditioning utility consumption information.

In further embodiments, the at least one premises information may include at least one premises utility consumption model comprising at least one premises characteristic associated with a premises, at least one utility consuming appliance associated with the premises and at least one estimated utility consumption information associated with the at least one utility consuming appliance. Further, the analyzing step 20008 of the method 20000 may include determining at least one lighting utility consumption information corresponding to consumption of the at least one utility by at least one lighting appliance based on the at least one premises utility consumption model. Further, the at least one utility fingerprint may include the at least one lighting utility consumption information.

In further embodiments, the method 40000 may include determining at least one end-appliance utility consumption information associated with at least one end appliance based on each of the at least one total utility consumption, the at least one environment conditioning utility consumption information and the at least one lighting utility consumption information. The determining may be a sub-step of the analyzing step 20008 of the method 20000. Further, the at least one utility fingerprint may include the at least one end-appliance utility consumption information.

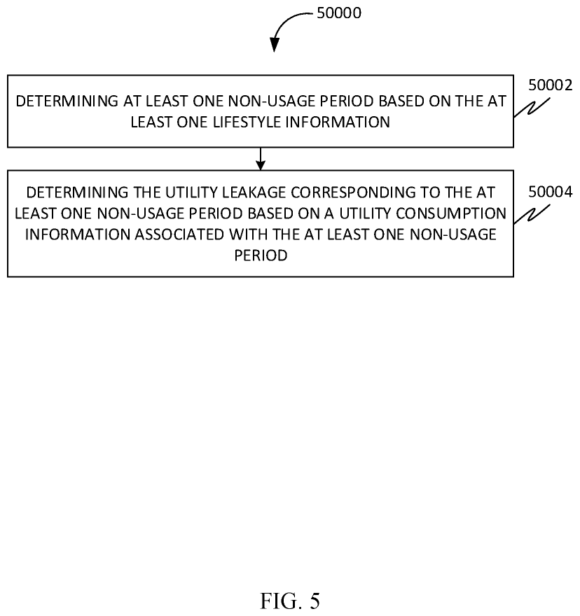

FIG. 5 is a flowchart of a method 50000 for obtaining determining at least one non-usage period and a utility leakage, in accordance with some embodiments. Further, the at least one utility fingerprint may include the utility leakage.

Further, at 50002, the method 50000 may include determining the at least one non-usage period based on the at least one lifestyle information. Further, the at least one lifestyle information corresponds to at least one activity performable in the at least one premises by the at least one occupant and at least one-time period associated with the at least one activity. Further, the at least one activity may include a “away time” as well. The step 50002 may be a sub-step of the analyzing step 20008 of the method 20000.

Further, at 50004, the method 50000 may include determining the utility leakage corresponding to the at least one non-usage period based on a utility consumption information associated with the at least one non-usage period. The step 50004 may be a sub-step of the analyzing step 20008 of the method 20000.

In further embodiments, the generating (at 20010 of the method 20000) of the at least one utility fingerprint may include generating an environmental impact information based on at least one of the utility leakage and the at least one utility consumption information. Further, the at least one utility fingerprint may include the environmental impact information.

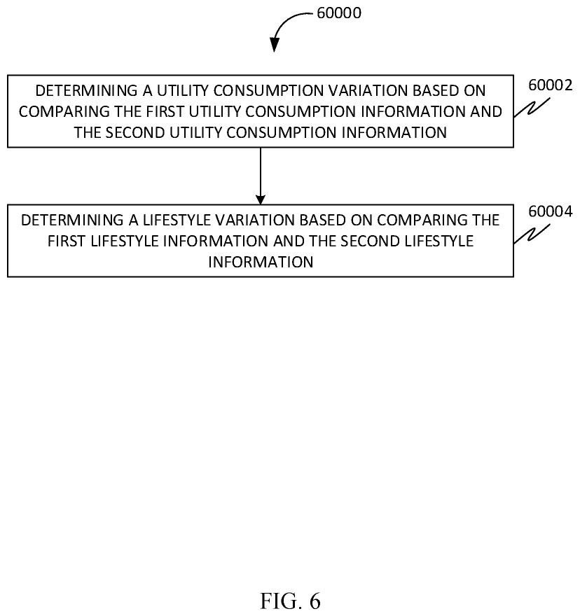

FIG. 6 is a flowchart of a method 60000 for obtaining a utility consumption variation and a lifestyle variation, in accordance with some embodiments. The at least one utility consumption information may include a first utility consumption information corresponding to a first time period and a second utility consumption information corresponding to a second time period. Further, the at least one lifestyle information may include a first lifestyle information associated with the first time period and a second lifestyle information associated with the second time period. Further, the second time period is later than the first time period.

Further, at 60002, the method 60000 may include determining the utility consumption variation based on comparing the first utility consumption information and the second utility consumption information. The step 60002 may be a sub-step of the analyzing step 20008 of the method 20000.

Further, at 60004, the method 60000 may include determining the lifestyle variation based on comparing the first lifestyle information and the second lifestyle information. The step 60004 may be a sub-step of the analyzing step 20008 of the method 20000. Further, the at least one utility fingerprint may include each of the utility consumption variation and the lifestyle variation.

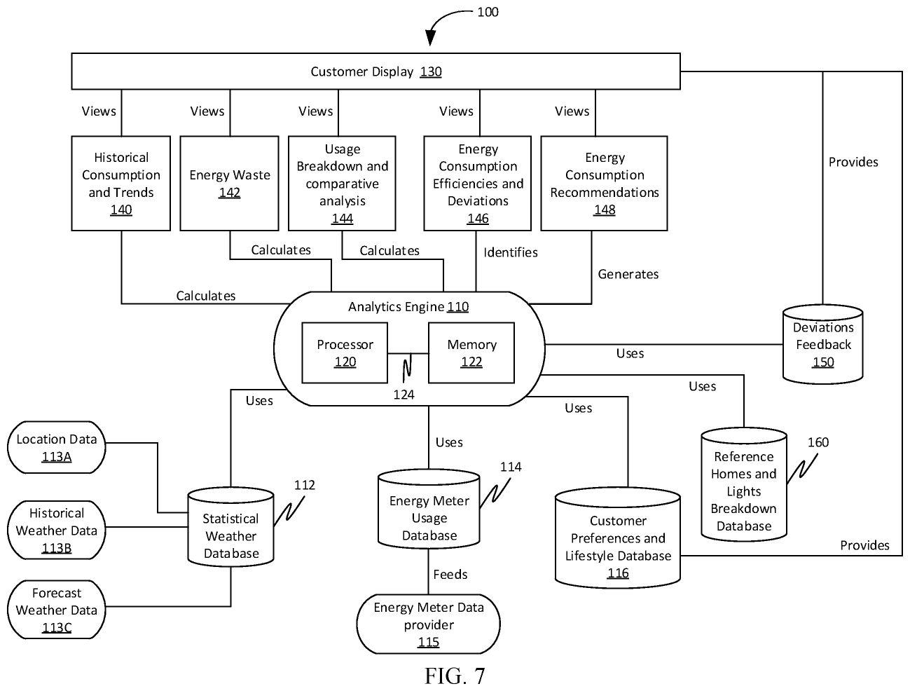

FIG. 7 depicts a simplified block diagram of one embodiment or configuration of the platform or control system 100 for end-use analytics and optimization of energy consumption of the present disclosure (hereinafter referred to as “platform” or “system”). The system 100 includes an analytics and statistical analysis component, which may include an analytics engine 110 and one or more databases 112, 114, 116, as discussed in more detail below. The analytics engine 110 may include a processor 120 and a memory 122 that can communicate via a bus or any other appropriate communication means 124. Although depicted as a single block representing a processor and a single block representing a memory in FIG. 7, a processor 120 of the system of the present disclosure may be one or more processors and similarly for the memory 122, a memory may be one or more memories.

Any memory, as used herein, may be operable to store instructions executable by a processor and may include one or more programs for one or more processors. The functions, acts or tasks illustrated in the figures or described herein may be performed by a properly programmed processor executing the instructions stored in a memory. The functions, acts or tasks may be independent of the particular type of instruction set, storage media, processor or processing strategy and may be performed by software, hardware, integrated circuits, firm-ware, micro-code and the like, operating alone or in combination. Any processor may utilize processing strategies that may include but are not limited to multiprocessing, multitasking, parallel processing and the like.

The analytics engine 110 may further have associated therewith, or include, at least one display 130 for a user, such as but not limited to a liquid crystal display (LCD), an organic light emitting diode (OLED), a flat panel display, a solid state display, a cathode ray tube (CRT), a projector, a printer or other now known or later-developed display device for selectively providing organized historical base data, processed data or other calculated information to a user in a graphical user interface (GUI). Any display 130 is an interface for the user to see the functioning of a processor, the results of the functioning of a processor, or specifically as an interface with the software stored in a memory or a drive unit. The system may use a display to request permission from a user for permission to access that user's historical energy usage data, regardless of where or how stored or by whom it is stored. Historical energy usage data is useful for performing some of the analysis as described later herein.

Additionally, although not depicted, the analytics engine 110 may have associated therewith, or include, an input device configured to allow a user to interact with any of the components of system. The input device may be a number pad, a keyboard, or a cursor control device, such as a mouse, or a joystick, touch screen display, remote control, voice activated control, or any other device operative to interact with the system. An input device allows the system to obtain information from the user/consumer that is useful in performing some of the analysis as described later herein.

The analytics engine 110 may also include a disk or optical drive unit as a memory 122. The disk drive unit may include a computer-readable medium in which one or more sets of instructions, e.g., software, may be stored. Further, the instructions may be used to perform one or more of the methods or types of analysis as described herein. During execution by a processor of the operations and functions of the analytics engine, the instructions may reside completely, or at least partially, within a memory and/or within a processor having an attached or associated memory. The memory and the processor also may include various types of computer-readable media as discussed above. Thus, a computer implemented system and method are part of the present disclosure.

The present disclosure contemplates a computer-readable medium 122 that includes instructions for execution by a processor(s) 120, or a processor that receives and executes instructions responsive to a propagated signal. The instructions may be implemented with hardware, software and/or firmware, or any combination thereof. Further, the instructions may be transmitted or received over an external or internal network via an appropriate communication interface 124. The communication interface may be included as a part of a processor or may be a separate component. The communication interface 124 may be created in software, may be a physical connection in hardware, or a combination of both. The communication interface 124 may be configured to connect with a network, the cloud, the web, external media, the display, or any other components in the system, or combinations thereof. The connection with a network may be a physical connection, such as a wired Ethernet connection or may be established wirelessly. Likewise, the additional connections with other components of the system may be physical connections or may be established wirelessly or may be combinations thereof.

For example, the instructions to perform the actions described below may be included in a memory 122. The processor 120 may execute the programs in a memory 122 and may receive inputs and send outputs via I/O to various other components or devices of the system. The system uses an open architecture for ease of operation, maintenance, improvement and updates. Again, FIG. 7 is a simplified block diagram of one embodiment or configuration of the platform or system 100 of the present disclosure and the interaction of a customer with that system or platform. The system manages the analytics engine 110 using analytics and statistical functions and uses as part of its inputs an energy meter database 114 and a customer database 116. The analytics and statistical functions of the analytics engine may be periodically updated to add to or improve functionality of the analytics engine. Moreover, the energy meter database 114 may receive data directly from energy meters (energy meter data provider 115). Energy meter data may also be data received from sensors resident at a customer premises but may be forwarded to the system for processing and analysis. Alternatively, the data sent from sensors may be sent directly to an energy meter database 114. Further, the analytics engine 110 may access data related to a customer residence or customer premises (such as a customer profile in the customer database 116). As discussed in more detail below, the customer profile may include data specific to the customer that may be used by the analytics engine 110 for end-use analytics and statistical methods and optimization for energy consumption.

The analytics engine 110, using selected analytics and/or statistical functions using various data bases such as, for example, but not limited to, the energy meter database, the customer database, weather data, and temperature data, may generate calculations, comparisons and recommendations 148 for a customer. For example, the analytics engine may receive historical energy usage data and then arrange and display historical and current energy consumption data and calculate desired consumption characteristics and trends, as discussed in more detail later herein. The customer may view the current energy consumption 140, 144 via an input/output device 130 (such as a display) dedicated to communication with, or periodically in communication with, the system or platform of the present disclosure. Or, the customer may view the current energy consumption via a computer, a PDA, and/or a mobile telephone. In addition, the analytics engine may generate energy consumption statistics and/or recommendations 148 to “save energy”, as discussed in more detail later herein. The system 100 may provide for display the results of any analysis to various devices, such as, for example, but not limited to, a cell phone, a tablet, laptop, etc. Further, the display 130 may show data obtained from deviations feedback 150.

More particularly, the present disclosure preferably provides a cloud or web-based platform 100 that includes the analytics and computational engine 110, and that will when initially accessed by a user, provide that user with a unique account identification for registration using a communication device 130, and then the platform 100 will use a cloud or web based graphical interface for communicating with that user on that user device. These communications may be for information flowing to the user as selected displays, or for a user to provide information to the platform for use in energy usage analysis for that user, as described more fully later herein. The device for communications with and use with the system may be portable and may be located on any type of computer, tablet, laptop, smart phone, or other smart device with communications abilities.

The platform of the system, using a cloud or web based graphical user interface (GUI) when accessed by a user, initially launches a user sign-up display, or a sign-in display, if the user already has an account with the system, and registers the user's device with the system and sets up network connectivity with that user device. The system is user friendly and easy to navigate and may employ a dash board to assist a user in operating the system. In addition, once set up, in one embodiment a user may be asked, via an electronic release form displayed by the GUI, for electronic confirmation allowing for access to selected user data, like for example, but not limited to, access to a database of historical energy consumption by that user from an external database maintained by some third party, and other protected historical or other personal data. Access to a user's historical energy consumption is needed in order for the system to perform analysis of the historical data for future energy use optimization and recommendations for reduced consumption. Personal information for a user may be encrypted when stored by the system.

Continuing to refer to FIG. 7, the platform 110 of the system 100, using one of many different formats of the web based graphical user interface (GUI), may ask the user to provide non-intrusive information regarding user lifestyle information and residence or premises information and properties, as described more particularly later herein. This user information is stored by the system in a user/customer database 116 and may be changed or updated at any time using that same GUI format. When changes are made, the system 100 may provide a display that may be altered and in some cases the analysis and results may be performed again with the new analysis and results being provided to the user.

The platform 110 of the system 100, after analysis of selected data, and using several different formats of the web based graphical user interface (GUI), may display on the user communication device (or display) 130 different energy consumption and utilization charts and reports from the information gathered from a smart meter database (and any other smart building appliances and devices) or a database of historical energy consumption by that user. Other GUI formats may be employed by the system to obtain additional data and/or information regarding the user or the user's premises. Multiple GUI formats are available for selection by the user for displaying comparisons and analysis results, and intermediate results of computations, as well as recommendations resulting from various types of analysis.

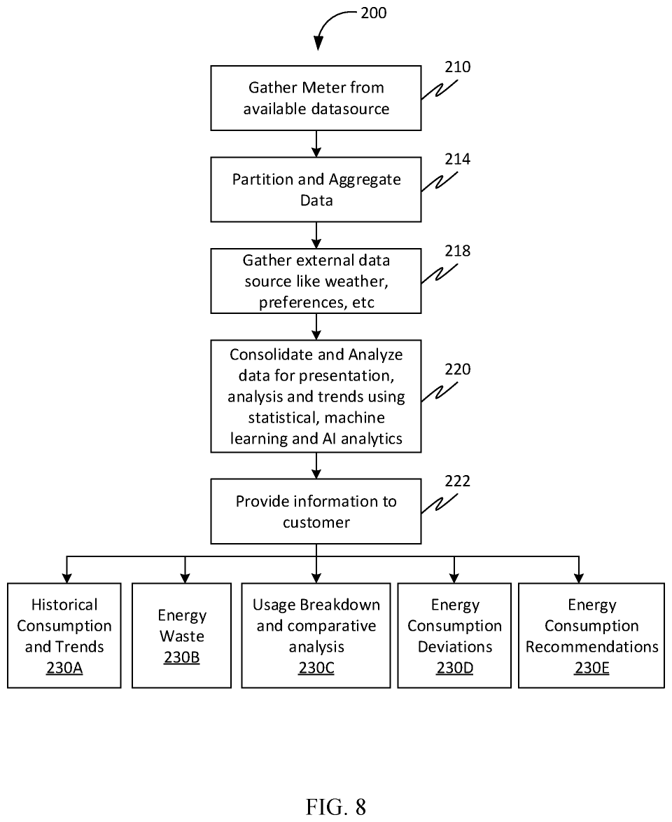

Referring now to FIG. 8, there may be seen a simplified flow diagram of the overall major processing steps (method 200) that the platform 110 may employ to receive and analyze the various data from the plurality of databases. More particularly, the analytics engine (or calculation engine) generates a unique energy profile that integrates as much energy usage data as is available, but preferably at least twelve months of energy usage data 210, partition and aggregate data 214, user profile data (e.g., lifestyle information and schedules, premises properties, location and schedules, etc., and also referred to as “customer data”), user preferences 218 (or customer preferences), and weather and external temperature data 218. Further, at 220, the method 200 may consolidate and analyze data for presentation, analysis and trends using statistical, machine learning and AI analytics. Further, at 222, the method 200 may provide information to customer.

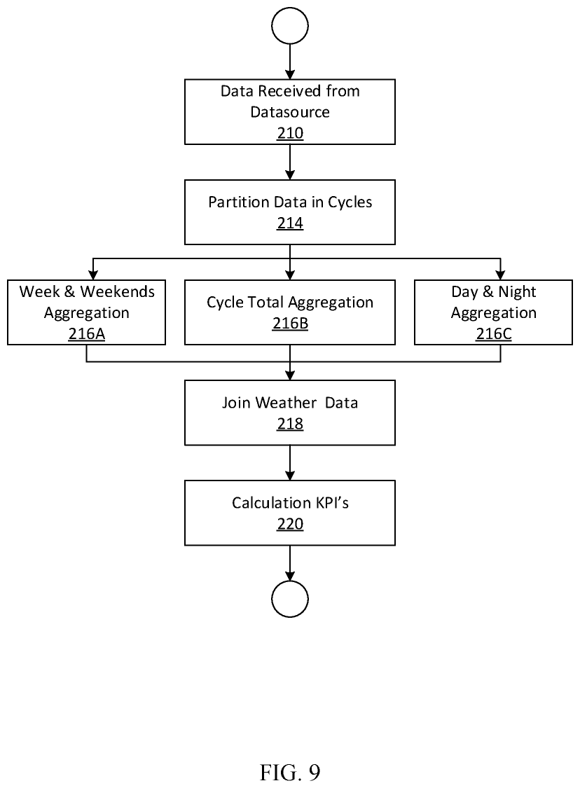

FIG. 9 illustrates in more detail a portion of the steps of the analysis steps and preprocessing of data before analysis as depicted in FIG. 8, but in a slightly different sequence. This illustrates that certain steps may rearranged and still provide the desired analysis and processing of the present disclosure. FIG. 9 illustrates that historical energy usage data may disaggregated into a plurality of different categories for analysis and comparative purposes. Those categories may include, and typically do include, those categories needed to calculate energy costs based on the various billing rules employed by energy suppliers; representative categories are for example, but not limited to, total aggregated usage amount 216b, daily aggregated usage amount 216c, time of use usage amount for each day of the week 216a, and other aggregated usage amounts based on scripted logic categories. Further, at 220, the method may include calculating KPIs.

Continuing to refer to FIGS. 8 and 9, and also to FIG. 7, it may be seen that the Cloud or web-based platform 110 of the present disclosure receives and integrates all the information and data gathered through the GUI, as well as all of the other data gathered from other data sources (e.g., external databases for weather, meter data, etc.) and used for comparisons, analysis, disaggregation and aggregation. The platform 110 conditions and converts all data in their respective various native storage formats from all the various data sources into one single and common interoperable database storage format for the system, using a data storage format. And that system databased format enables two-way communication between a system database and the original database providing the data to the system to allow for periodic data updates of data stored in the system.

The Cloud or web based platform 110 of the present disclosure receives and integrates weather information 218 (112) and generates significant weather or other types of events to evaluate certain consumption responses, and provides a display of and storage of enhanced historical energy usage data 230a (140, 144) that has been analyzed and disaggregated for main electrical consumption categories (e.g., HVAC, pump pools, clothes drying, etc.) based on selected disaggregation or partitioning methods or algorithms 230c, and for some embodiments, integration of actual measurements from smart devices. The historical energy usage data 230a may be partitioned (or disaggregated) into different time periods or “cycles” such as for, example, but not limited to week and weekend aggregation, total usage aggregation, day and night aggregation, etc., as described regarding FIG. 9. These various cycles are useful for later analysis and may also be displayed for comparative and analytic tending purposes. Further, the energy consumption deviations 230d and energy consumption recommendations 230e may be displayed for the customer.

More particularly, the Cloud or web based platform 110 of the present disclosure provides a calculation and analytics engine capable of initially generating a unique customer multidimensional energy profile (Energy FingerPrint) that uses as much energy usage data as is available, but preferably at least 12 months of historical energy consumption 210 and in addition integrates household lifestyle activities and user preferences 218 (116) to create a multidimensional envelope providing a more accurate model (e.g., digital twin) of the user's consumption based on a user's premises and its devices, and the user's priorities, behaviors, and activities.

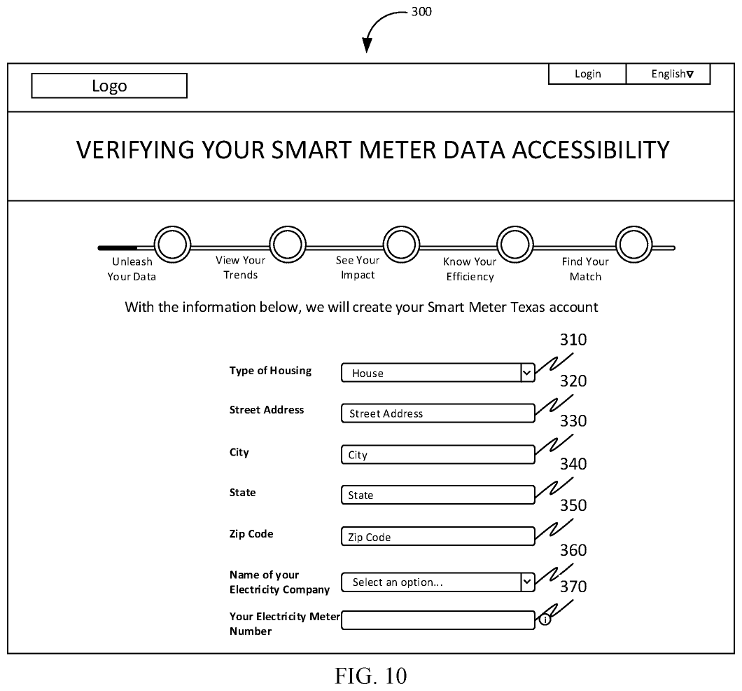

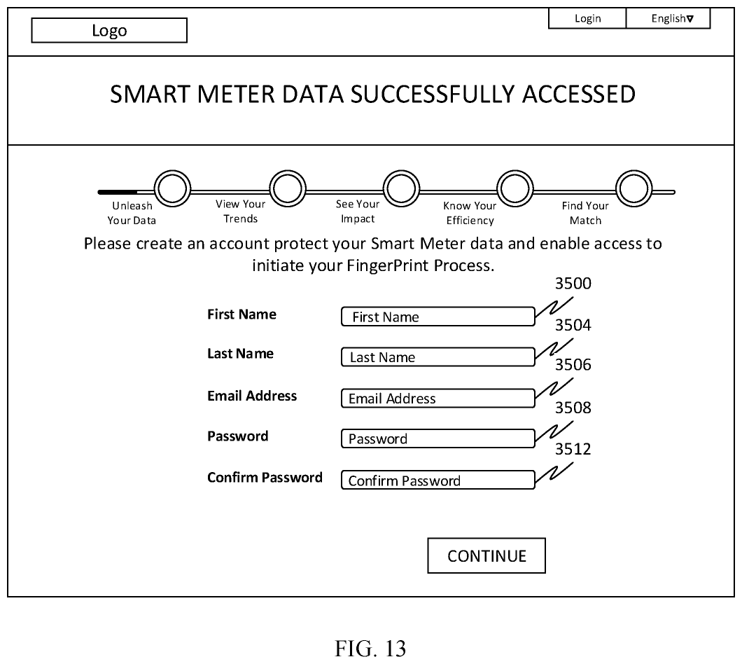

The platform of the present disclosure preferably provides a responsive web-based interface to provide a user with a way to initially sign up and then later sign in the system, and to capture user information, such as, for example, but not limited to lifestyle information and schedules, residence properties and information, and consent for accessing historical energy consumption data. A representative GUI for the initial communications with the system 100 is depicted in FIG. 13. Moreover, FIG. 13 is the initial GUI to create an account using a customer name 3500, 3504, email address 3506 and password 3508. In addition, a check box 3512 is used to confirm authorization to use the address and to access usage data for that address. As may be seen from FIG. 10 (user interface 300), once a customer account is setup, additional information requested may include, but is not limited to, user name, address 310-350, user energy supplier 360, and electricity meter number 370, as well as asking for permission to retrieve historical energy usage data for that user 380. Although, once a user is registered with the system, a user may later access the system using any other device, using at least a user logon identification (email address) and a password, which is depicted in FIG. 13, but is not depicted in FIG. 10.

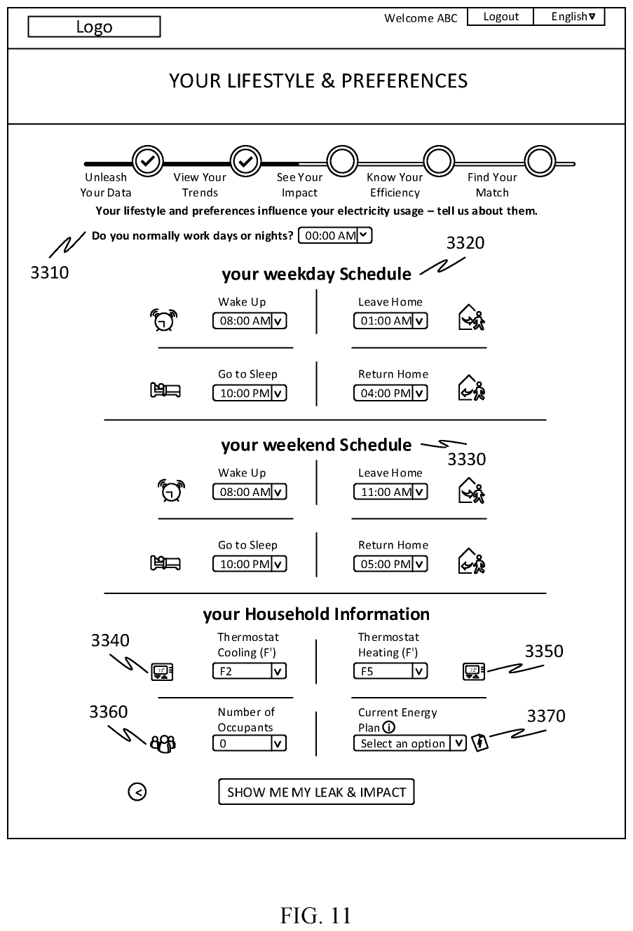

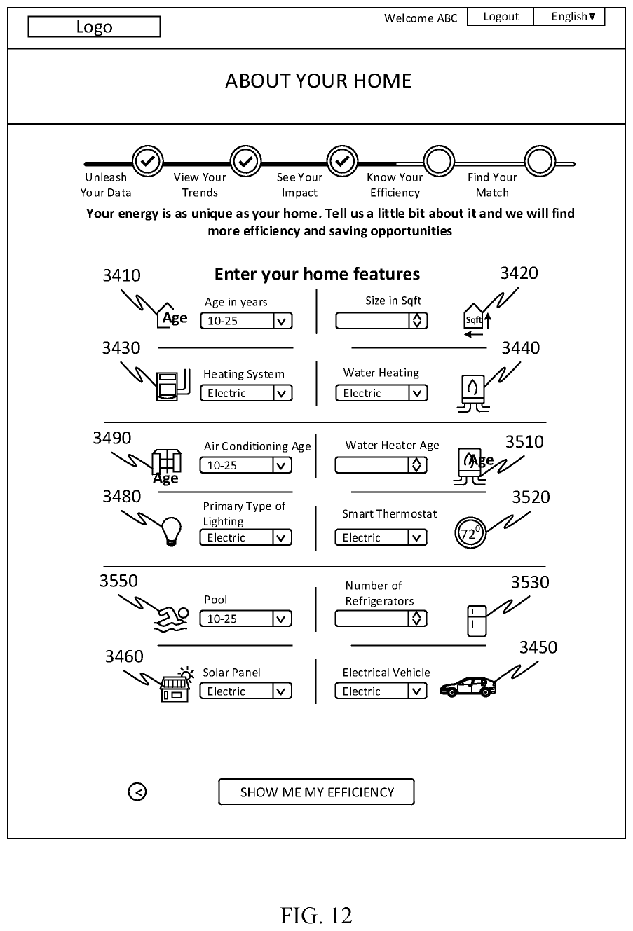

The Cloud or web-based platform 110 of the present disclosure also combines household information from a user (e.g., dwelling size, number of rooms, appliances, number of occupants, etc.), lifestyle behaviors 116 and uses a basic disaggregation algorithm that provides a general split of historical energy consumption into buckets (e.g., A/C, heating, pool, clothes dryers, etc.). Referring now to FIGS. 11 and 12 there may be seen representative GUI's for obtaining lifestyle information or preference information from a user and other aspects regarding the use of energy and their premises. FIG. 11 is used to initially get information from the user on lifestyle information and preferences, like for example, but not limited to sliders for indicating periods of sleep, work, and being at a premises for a twenty-four-hour period 3320, 3330, how many people live in the house 3340, how many are in the house during the day 3350, preferred heating and cooling set points 3360, 3370, normal working hours 3310, energy supplier 3380 and plan 3390, etc. While FIG. 12 may be used to get information from the user on the user's premises, such as for example, but not limited to year built 3410, size 3420, heating system type 3430, cooling system type, hot water heater type 3440, number of refrigerators and freezers 3530, type of light bulbs used 3480, age of heating/cooling system 3490, age of water heater type 3510, presence of smart devices 3520, swimming pool 3550, electric car(s) 3450, back up electricity generators or batteries, solar panels 3460, etc. The information from a GUI like that of FIG. 12 is needed for more detailed analysis of historical usage data and for analysis and presentations for potential recommendations to decrease energy consumption, as described more fully later herein. This type of data may and other data in the system may be encrypted or otherwise provide with appropriate data security.

The Cloud or web-based platform 110 of the present disclosure provides a calculation and analytics engine capable of generating a unique customer multidimensional energy profile (also known as an Energy FingerPrint) integrating the historical (for example: 12-24 months) electricity consumption 210, user profile (lifestyle & dwelling properties), customer preferences 218, and for calculating a carbon footprint (current, projected and any delta in carbon footprints). The platform 110 may also provide automated initial and on-going periodic reports 230c capability, for example, but not limited to comparison of the current period's energy consumption vs. consumption (1) in previous/last time period, (2) in same time period last year, (3) by other users in same zip code or area, (4) by other periods or time frames. FIGS. 4, 5, and 6 are described later herein and illustrate representative GUI formats for these types of comparisons. These types of comparisons are useful for trends over time and over seasons. The system may analyze and compare various data to generate and display key performance indicators, as noted later herein. However, other more complex comparisons, analysis results, reports and exceptions may similarly be easily displayed.

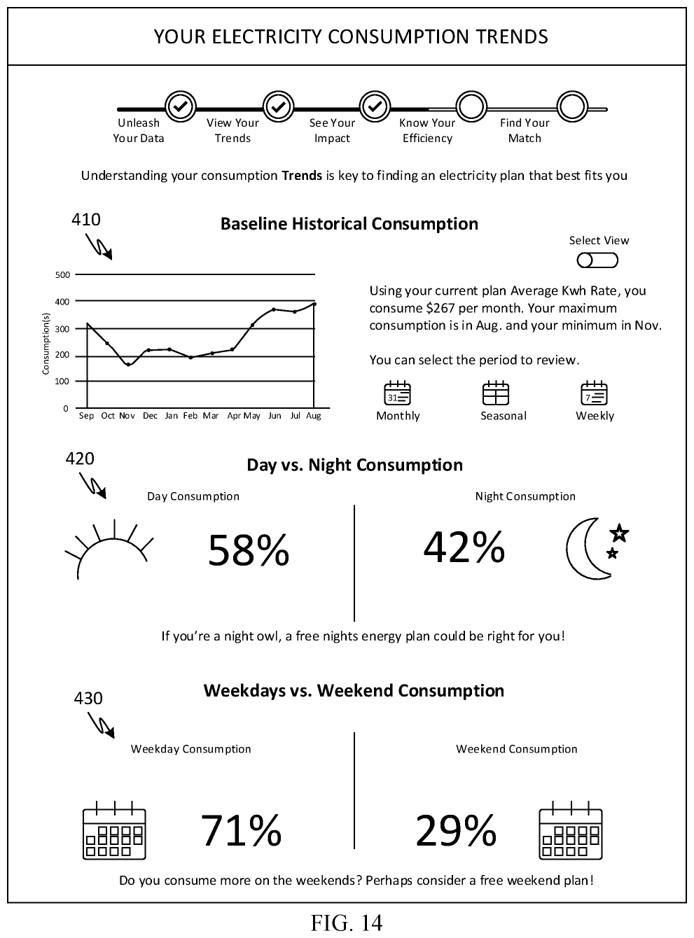

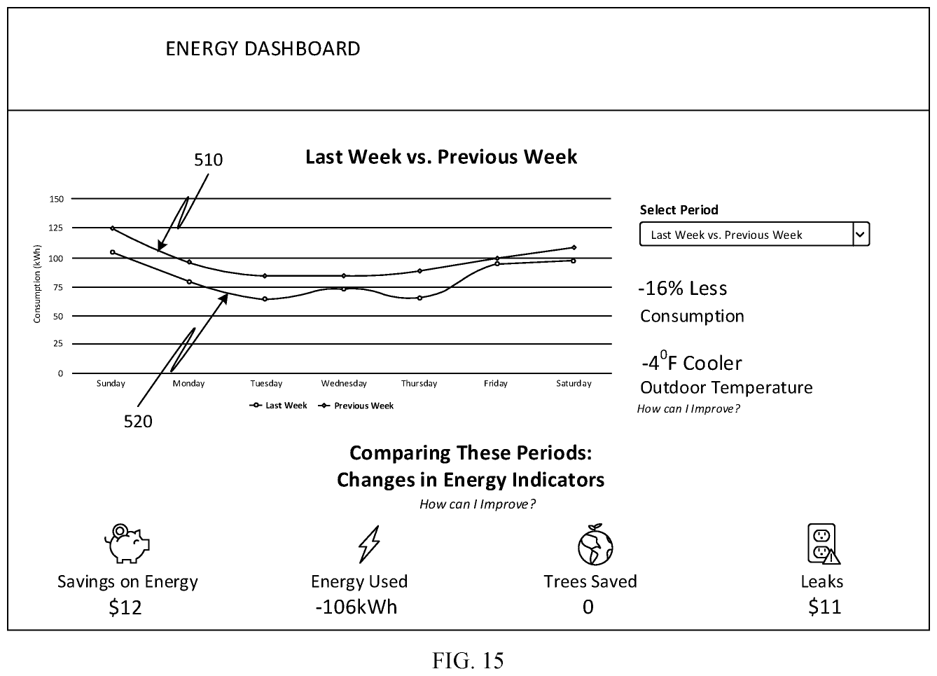

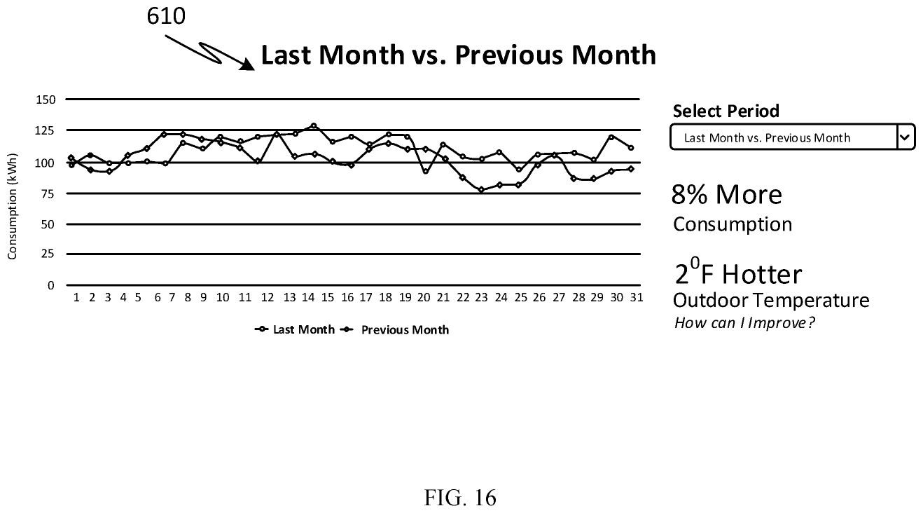

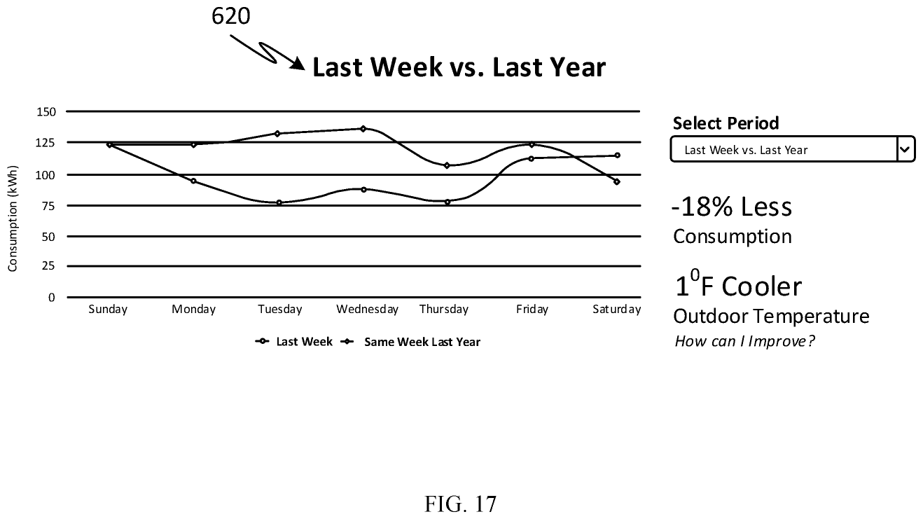

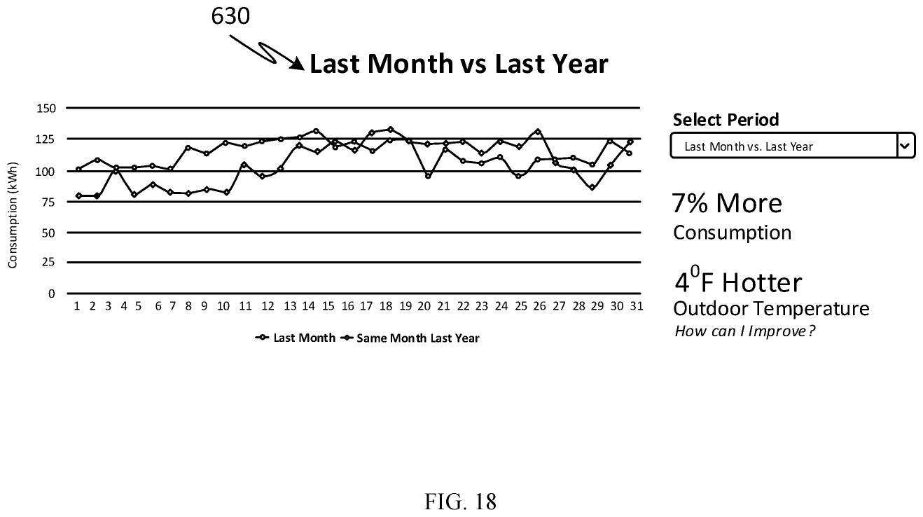

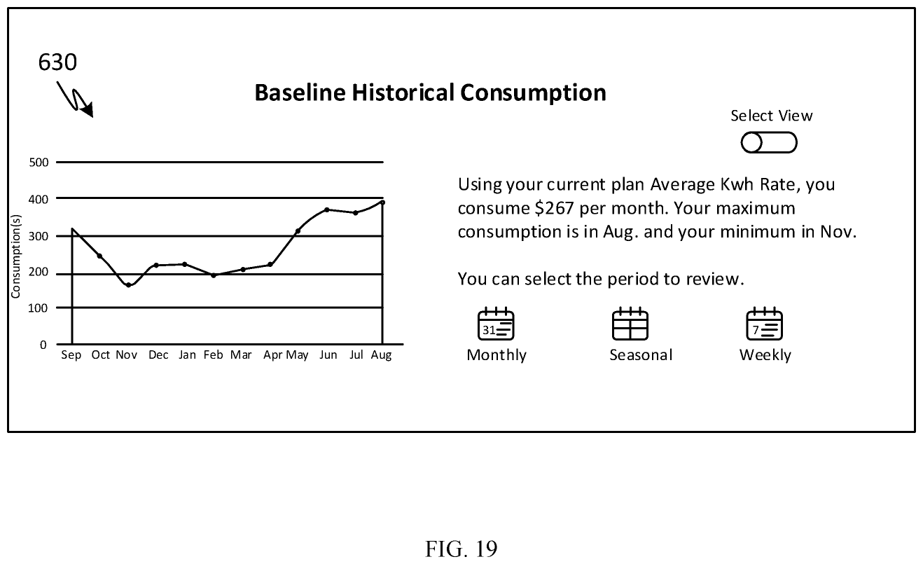

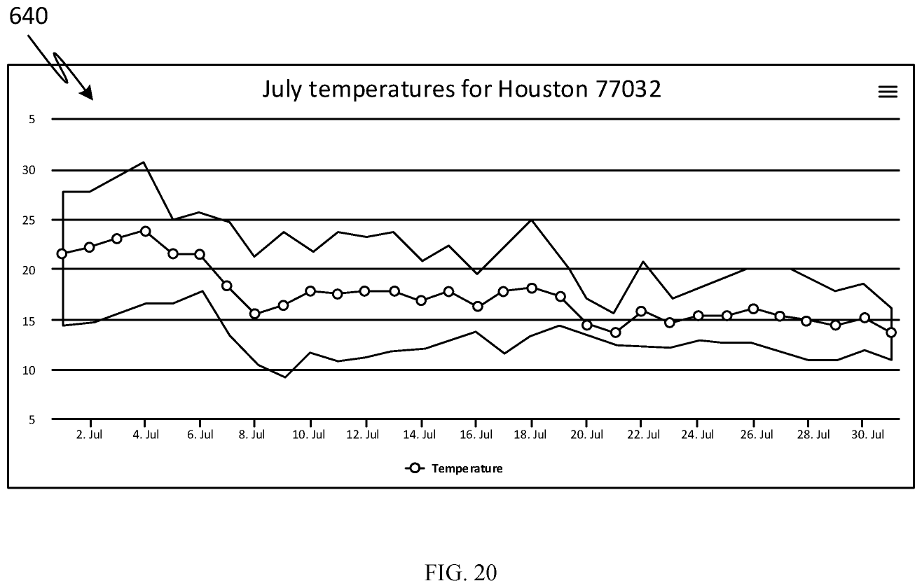

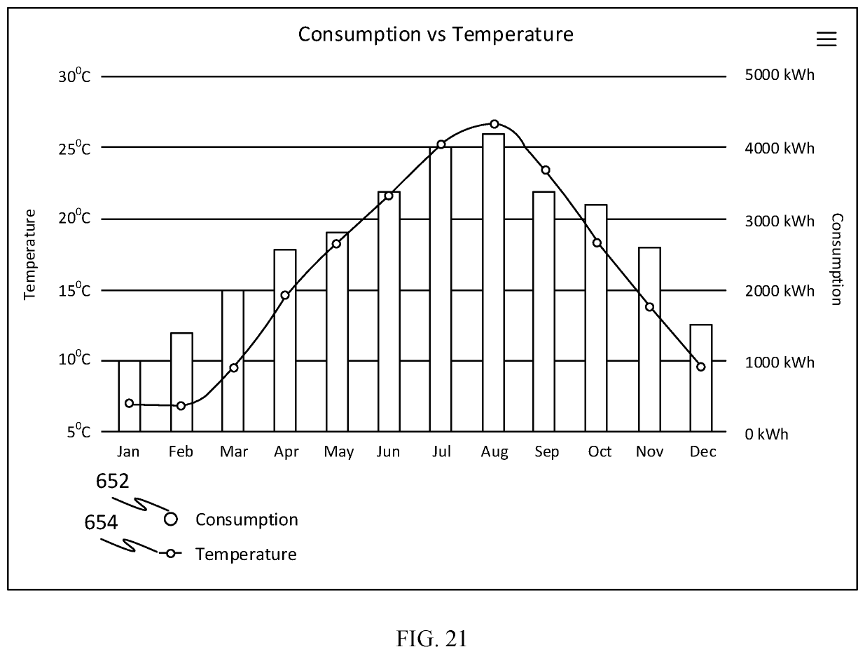

In more detail, the Cloud or web-based platform 110 of the present disclosure downloads historical energy consumption 210 from a depository for historical storage of energy usage data stored at some sampled rate (like for example but not limited to every 5 or 15 minutes). From this time series for energy usage data, the platform extracts by disaggregation and aggregation consumption and lifestyle behaviors (including times of use, e.g., day/night, peak/off-peak, weekday/weekend as noted in FIG. 9). Referring now to FIGS. 4, 5, and 6, there may be seen representative figures generated by the platform (e.g., for a control system) from the downloaded historical usage data regarding the historical use of energy and associated lifestyle behaviors for a user's premises. The types of aggregation that may be performed on the historical usage data, may be for example, but not limited to total consumption (cycle total), daily consumption (aggregates consumption per day), and hourly and day of week consumption (to provide energy consumption trends over time periods, including, but not limited to, individual days, nights, weeks, weekdays, weekends, months, seasons, etc.), etc. This aggregated data is stored in a system memory in a replicated distributed database with controlled replication settings to reduce data loss from any processor (or node) issues. Referring now to FIG. 14, there may be seen a set of representative GUIs for total historical consumption 410, day and night comparisons (which period of time may be defined by the energy provider) 420, and weekday and weekend comparisons 430. That is comparisons for energy consumption in total 410 and in unique adjacent time periods 420, 430. Similarly, FIG. 15 illustrates two representative GUIs for last week and previous week comparisons 510 (e.g., the same time period, a “week”, but at different times, “last” week and the “previous” week) and last month and previous month comparisons 520. That is, comparisons for energy consumption in the same time periods for different times 510, 520. While FIGS. 16-18 illustrates two GUIs for last week and same week from last year comparisons 610, and last month and same month from last year comparisons 620 and last month vs last year comparisons 630. That is, again, comparisons for energy consumption in the same time periods but for different times 610, 620. This type of information and data may be used for trending and analysis for reasons why the comparisons are different. FIGS. 19-20 depict a historical baseline from the historical previous usage data 630 along with some descriptive text explaining this data and a chart representing mean temperatures with variances in Houston in the area of zip code 77032 from the temperature data. FIG. 20 depicts July temperatures for Houston 77032. FIG. 21 depicts average monthly temperatures 654 along with average monthly consumption 652. Again, this type of information and data may be used for trending and for educating a consumer about annual usage (or other periods) and analysis for reasons as to why comparisons may be different.

Continuing to refer to FIG. 7, the Cloud or web-based platform 110 of the present disclosure also uses historical weather data 113b for the physical geographical location 113a of a premises to normalize energy consumption based on weather and temperatures. Note that the resulting Energy FingerPrint is dynamic and may change over time based on seasons, adjustments in lifestyle, behaviors, preferences and consumption. Further, forecast weather data 113c may be obtained.

The Cloud or web-based platform 110 of the present disclosure may use a monthly historical consumption as a reference to project the consumption and cost for each individual month and may be adjusted for location and/or seasonal effects (e.g., 2017 had Harvey effects in some areas in Texas that didn't repeat in 2018 and might have impacted electricity consumption). The system will recognize weather events (like Harvey) and its impact on consumption and make suitable adjustments in its calculations. Other types of events may also impact consumption and suitable adjustments may be made in the system's analysis and calculations.

Continuing to refer to FIG. 7, the Energy FingerPrint is the unique digital model/twin from which are determined, for example, but not limited to the following reports and analysis, historical consumption and trends 140, energy waste 142, usage breakdown and comparative analysis 144, energy consumption efficiencies and deviations 146, energy consumption recommendations 148. The system 100 may display information in GUI's, like for example, but not limited to the consumption statistics for monthly consumption, Day vs Night consumption 420, Week vs Weekend consumption 430, and Seasonal Consumption; a carbon footprint based on the current energy plan for energy supplier; efficiency factor information 116 defined as, for example, but not limited to Idle vs Away consumption comparison, and Idle vs Away Seasonal Indexes (“Idle” and “Away” consumption are discussed later herein below); efficiency indicators, such as for example, but not limited to LED lights usage, cooling temperature set point vs National Average Cooling Temperature, heating temperature set point vs National Average Heating Temperature; comparative premises analysis from a monthly consumption vs reference building consumption; and consumption breakdown by device and appliance, and other similar GUI formats like those illustrated in FIGS. 4, 5, and 6.

### Energy Leakage

The energy leakage consumption calculation of the present disclosure identifies quantities of electricity unintendedly consumed during time periods in which there are no occupants in a given premise (“Away”) compared to the electricity consumed during times in which a premises occupants are not actively using electricity (e.g., sleeping periods, a.k.a. “Idle” time). The energy leakage starts with the identification of the idle and away energy consumption periods. As noted earlier in FIG. 11 the customer provides inputs about schedules including but not limited to number of occupants, time to go to bed, wake up time, time at which the occupants leave the premise, and the time at which the occupants return.

Most existing platforms for determining a base and consumption load use sub-metering and/or data science techniques to determine periods and amounts of electricity usage but focus on monitoring and quantifying how much electricity is consumed when the household is actively engaged in activities that use electricity which are part of their daily routines and lifestyles. While there are energy saving opportunities from that knowledge, and almost all electricity consumers are interested in saving electricity and money, there is no significant interest in sacrificing comfort or making changes to lifestyle and habits in order to achieve that goal.

The objective of the energy leakage calculation of the present disclosure is to identify ways to save electricity in non-intrusive ways that do not interfere with or limit a consumer's intentional engagement in activities that utilize electricity (e.g., watching TV, using computers, cooking, doing laundry, etc.).

The energy leakage calculation of the present disclosure directly links customer historical usage, lifestyle schedules, preferences, and settings through statistical analysis and pragmatic methods to identify non-intrusive ways to save energy without requiring efforts by the customer to change any regular activities in which electricity is actively consumed in the household. This integration of a plurality of customer inputs, data and behavioral science brings visibility to previously unknown wasted electricity, quantify its associated cost and environmental impact, and equally important provides a non-intrusive way to save energy. This energy leakage calculation offers cue rich, pain free path to positive action for reducing energy consumption. To mitigate for input bias potential in the schedules users input to the system, the idle time usage may be determined using clustering analytics for unsupervised learning, as described herein below. Clustering analytics is a method for unsupervised machine learning algorithms. Typically, unsupervised algorithms make inferences from datasets using only input vectors without referring to models or known, or labelled, outcomes. The objective of clustering methods is simple; group similar data points together and discover any underlying patterns. To achieve this objective, clustering techniques such as, but not limited to K-Means, X-means, or Probability Methods (e.g., Gaussian Mixture Models) look for a fixed number (k) of clusters in a dataset. Clustering methods when applied to energy usage data allow for the classification and visualization of period usage data into k number of clusters. Each cluster may then be identified as a period of high, low, or nominal usage.

However, the non-probabilistic nature of k-means and its use of simple distance-from-cluster-center to assign cluster membership leads to poor performance for many real-world situations. Given simple, well-separated data, k-means finds suitable clustering results. From an intuitive standpoint, any clustering assignment for some points is probably more certain than for others; for example, if there appears to be a very slight overlap between the two middle clusters, the assignment between which of the two choices may be ambiguous in the cluster assignment of points between them. The k-means model has no intrinsic measure of probability or uncertainty regarding assignment of data as part of cluster assignments. Probability based methods (e.g., Gaussian mixture model (GMM)) attempts to find a mixture of multi-dimensional Gaussian probability distributions that best model any input dataset. In the simplest case, probability methods such GMMs can be used for finding clusters in the same manner as k-means. However, the two disadvantages of k-means-its lack of flexibility in cluster shape and lack of probabilistic cluster assignment-mean that for many datasets (especially low-dimensional datasets) it may not perform as well. However, the use of such methods (e.g., GMM) overcomes these limitations, and provides for a more accurate analysis of energy usage for determining idle time data. For example, A Gaussian mixture model (GMM) has soft boundaries and may have a single point assigned to two different clusters but with different degrees of belief (e.g., 60% in one cluster and 40% in the other cluster).

The clustering analytics process used may be a straightforward k-means method or a Gaussian approach with the use of probability to help classify the data. Further, the results of a Gaussian mixture model on actual energy usage data may be plotted along the y-axis for a specific one-week period for a specific premise and along the x-axis represents energy usage during fixed times during each day.

The classification cluster that contains the energy usage and timestamp of lowest usage 1110 may be employed as the electricity consumed during times in which premise occupants are not actively using electricity (e.g., sleeping periods, lowest usage, a.k.a. “idle” time). See, for example data points in clusters 1120, 1130, and 1140. Once all points are assigned to a cluster using the Gaussian distribution, then statistical inferences (e.g., mean and variance) may be determined for that cluster; these statistical inferences may then be used for analysis, forecasting and other related uses.

These Gaussian methods (mixture model cluster classification techniques) may be further developed to identify, in real or near-real time, outliers and anomalies through statistical techniques using the mean and standard deviation, and other estimators against each individually computed cluster value. The determination of the assignment of a new data point or set of data points to its classification may be achieved via Euclidean geometry as well, as an alternative.

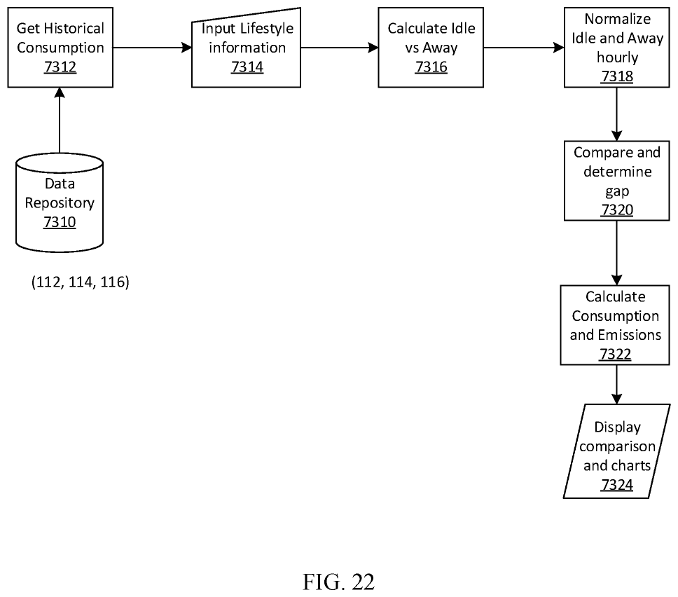

Referring to FIG. 22, the basic calculation steps for energy leakage consumption are as follows, historical energy consumption information 7312 is retrieved from a data repository 7310 (e.g., cloud, server, data lake, the databases 112, 114, 116 of FIG. 7 in parenthesis, etc.) along with customer input of lifestyle information 7310 regarding activities and schedules using a web browser GUI user interface (as depicted in FIGS. 11 and 12). More particularly, the calculation steps are as follows, idle and away periods are initially determined by using and combining multiple methods, like inputs from a customer, or use of machine learning algorithms including machine learning clustering techniques for unsupervised learning, like for example but not limited to, a Gaussian mixture model for classification of data, as described earlier herein. Further, Historical Consumption 7312, Input Lifestyle information 7314 and Calculate Idle Vs Away 7316 are obtained.

Next the energy consumption during idle and away periods is normalized 7318 to adjust for outdoor temperature differences, followed by normalization of energy consumption during idle and away periods accounting for scheduled operation of appliances (e.g., pump pools running during away periods, etc.). Idle and away period data are then compared to generate the leakage 7320. And, if desired, then a calculation and comparison of average hourly electricity usage during idle and away periods may be made, followed by an estimation of the resulting associated cost and emissions 7322 to the environment. The results from these calculation steps may then be displayed 7324 as descriptive analytics in formats such as for example, but not limited to idle and away electricity consumption and associated energy leakage, cost and emissions over a period of time (e.g., annual, monthly, weekly, etc.). These steps are more fully described hereinbelow.

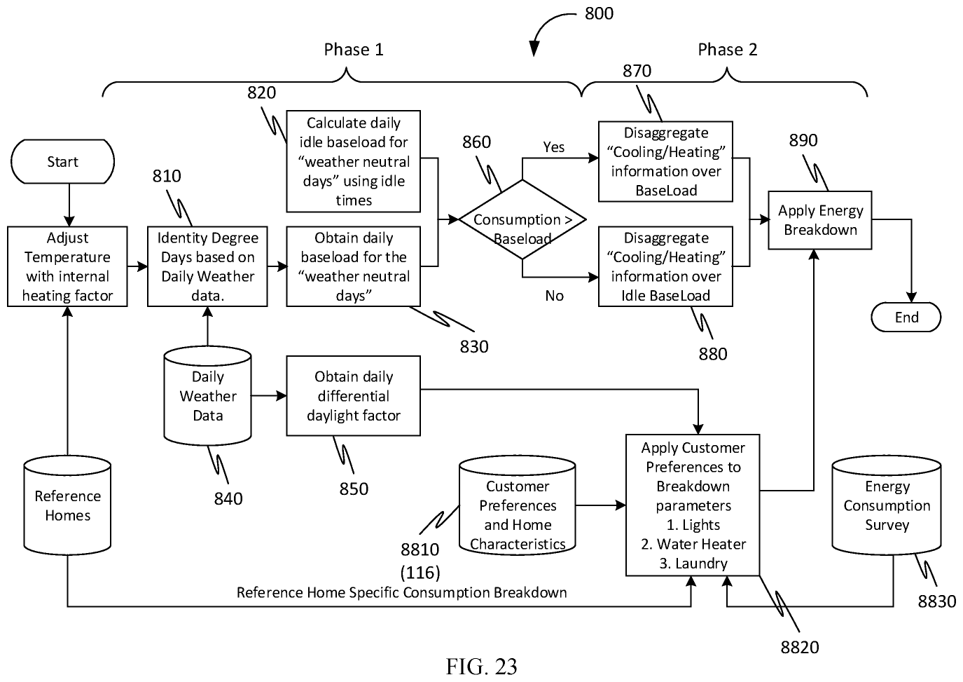

Referring now to FIG. 23, there may be seen additional details (method 800) regarding selected steps of FIG. 22. More particularly, it may be seen that more details 810 are provided regarding internal temperature for a residence compared to weather data 840 for outside temperature for each day (or other selected period of time) to determine “weather neutral” days (or “degree days”) 820, 830. Further, the weather data 840 may be used to obtain daily differential daylight factor 850. For those “weather neutral” days, a determination is then made as to whether that day is labelled as an “idle” day 820 or a “baseline” day 830, based on energy consumption for that day. The energy consumption for those days is then disaggregated 870, 880 to remove preselected appliance consumption (for example, but not limited to heating and air conditioning systems, etc.) for energy breakdown. The breakdown data is then displayed in a variety of different formats, along with breakdowns 890 for other appliances, like for example, but not limited to, lighting, washing machines, dryers, etc.

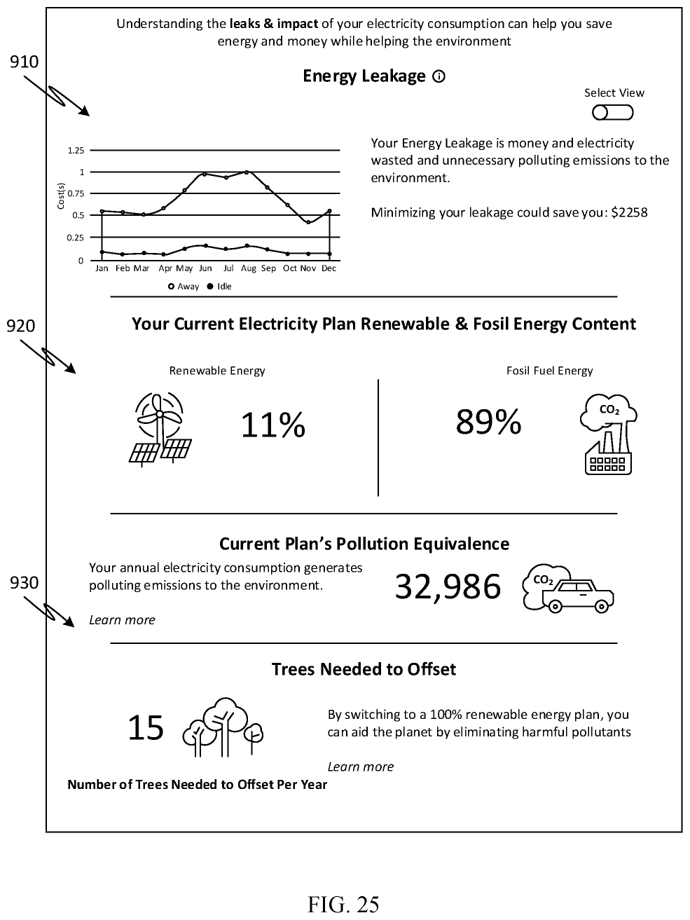

Referring now to FIG. 25 there may be seen a representative figure in a representative GUI format generated by the platform 100 from the analyzed data regarding the energy leakage (or unnecessarily consumed or used energy) for a user's premises 910 and its environmental impacts 920, 930 in easy to understand language. The energy leakage consumption calculation of the present disclosure identifies quantities of electricity consumed unintendedly during time periods in which there are no occupants in the given premises (away) compared to the electricity consumed during times in which premises occupants are not actively using electricity (e.g., sleeping periods, a.k.a. Idle time).

Consumption Breakdown

The energy consumption breakdown starts with the identification of the energy consumption base load. As noted in FIGS. 8 and 9, the consumption base load is calculated using at least the historical weather information 7312. The weather information used by the system is stored in a weather database 113b for a specific location or area 113a and used in calculations based on, for example, but not limited to hourly or other periodic historical weather and temperature data. This weather data is then used to identify the days when the external temperature does not impact the energy usage associated with cooling or heating of a premises using as reference the personal preferences of the user regarding heating and cooling set points for residence temperatures. The base load calculation takes into account the hours of daylight to adjust the consumption related to lights in addition to the effects of the weather's daily hourly temperatures 7318.

In more detail, the energy consumption analysis breakdown depicted in FIG. 23, is a hybrid method to determine the electricity consumption by end-use appliances to assist in understanding the contribution of specific appliances usage to the total electricity consumption of a given premises. It may assist in assessing the performance of such appliances and in identifying replacement savings opportunities.

As noted earlier herein with regard to the discussions of FIG. 8, the analysis starts with an analysis of at least 12 months of electricity usage data in, for example, but not limited to an electricity consumption time series using a pre-processing step that, aligns in time and unifies the sampling rate of the electricity consumption time series with data from any source. Thus, usage data can come from different sources and with different uniform or non-uniform sampling rates. The data may be collected not only by smart meters but any other hardware or databases. Furthermore, it can come from a single source with non-uniform sampling rate

After the usage data sampling rate is preprocessed, the location and historical outdoor temperature information over the same time period for a given premises associated with that location (which may be estimated) 840, and the customer input about premises characteristics, schedules and preferred space heating and cooling setting preferences 8810, 8820 for that premises may be collected for further analysis and processing. Further, data may be obtained from energy consumption survey 8830.

The method used by the system of the present disclosure may use and integrate or compare three approaches:

a) First, a set of physical methods are used to determine the amount of electricity used for air conditioning, space heating and lighting.

The determination of electricity usage related to air conditioning and space heating starts with the base load calculation using at least 12 months of historical electricity consumption data, along with the consumer's preferences for cooling and heating set points, and the outdoor weather information at the user's location. The method determines a base load.

This method is a variation of the well-known “degree days” 810 approach to mitigate the potential effects of unusual or non-¬uniform electricity consumption patterns and behaviors. The first step is the correlation and aggregation of the energy consumption to account for outdoor temperatures 820, 830. The calculation starts by analyzing the historical hourly weather information (such as outdoor temperature, humidity, UV index, etc.) during at least the last 12 months (depending on time period for which the historical usage data is available) for the given premise location and identifying the dates in which the mean outdoor temperature is close to the preferred space heating and cooling set points adjusted for internal premises use heat generation and has a standard deviation within a predefined range.

The electricity consumption associated with those “weather neutral” dates is then calculated considering that given such outdoor temperature range there should be no electricity consumption associated with indoor space cooling or heating 860. The amount of electricity consumption for those “weather neutral” dates is established as the given premises electricity base load comprising the use of electricity by all end-use appliances with the exception of electrical space heating or cooling 870, 880.

In addition, the idle energy consumption during the “weather neutral” days is calculated for a premises considering only a range of time when a premises is mostly idle (for example, during sleeping hours). This idle energy consumption is used for the case where the actual energy consumption falls below the base load as determined hereinabove.

The delta between total electricity consumption and the determined base load consumption is assumed to be the electricity usage by electrical space heating and/or cooling.

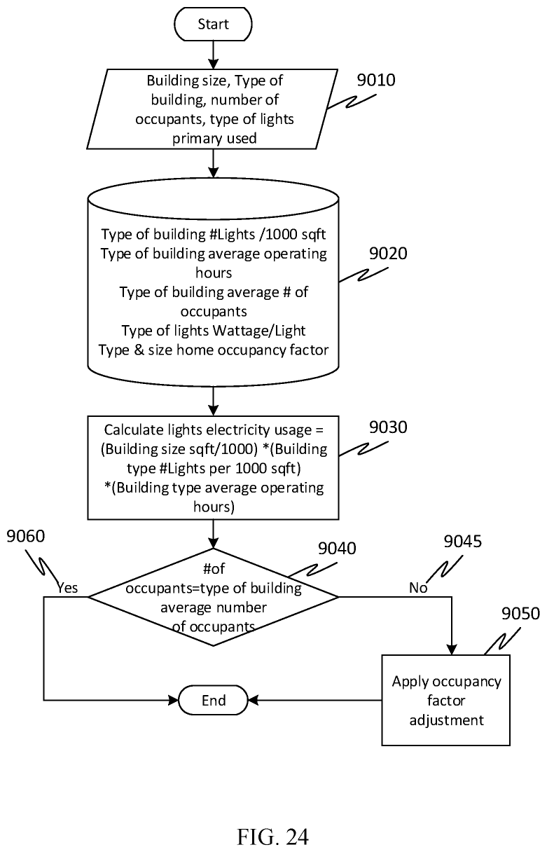

The flowchart of FIG. 23 illustrates the main steps for the method just described. ii) The determination of the electricity usage related to lighting uses a hybrid method integrating physical and statistical data and modeling. As illustrated in FIG. 24, the first step consists of gathering the following inputs 9010 regarding a premises: (or building) size, type of building (commercial, industrial, residential: single family, apartment, or mobile home), number of building occupants, and the primary type of lights used. The historical database 9020 employed should contain statistical and physical information related to the number of lights per 1,000 sq. ft. for each type of building, the average wattage per type of primary lights, the statistical number of effective hours of lights usage per type of building, the average number of occupants per type and size of building and the type and amount of building occupancy. Second, using statistical information from the database 9020 about the number of lights per 1,000 sq. ft. for the given type of building entered, the total number of lights in the given building is calculated. Third, the electricity consumption per hour for all the lights in the building is calculated by multiplying the average wattage per type of primary lights used by the total number of lights 9030. Fourth, the statistical number of effective hours of lights usage per type of building is multiplied by the electricity consumption per hour previously calculated 9040. Fifth, an occupancy adjustment “factor” 9050 is calculated based on the number of occupants and the size of the building, if it is determined (9045) number of occupants are not equal to type of building average number of occupants. Finally, the occupancy adjustment factor may be applied to the electricity consumption for lights usage calculated using the previous steps resulting in the electricity consumption related to lights usage in the given premise. If it is determined (9060) that the number of occupants are equal to type of building average number of occupants Again, FIG. 24 illustrates the steps for the method just described.

Publicly available data sources for this statistical light energy consumption information include but are not limited to the USA Census databases and statistics, the USA Energy Information Administration surveys and statistics.

b) As additional data sets in a database become available, the traditional “degree days” method may be applied to the data on an aggregated basis to mitigate/normalize for unusual or non-uniform electricity consumption patterns and behaviors within individual data sets. Based on this analysis the predefined number of degrees that account for internal building use heat generation is fine-tuned and may be correlated to particular premises features including, but not limited to, premises age, size, number of occupants, etc. c) Lastly the physical model for the calculation of the amount of electricity used for air conditioning, space heating, and lighting explained above is coupled with statistical modeling of end-appliance building electricity consumption (this can be done using among others a database of actual historical electricity consumption measurements by end appliance—sub-metering-, disaggregation of high frequency electricity consumption total loads, or public data sources including Information Energy Agency (IEA) end use appliances consumption survey).

Statistical modeling is also used based on an Information Energy Agency (IEA) end-appliance building electricity consumption survey.

This statistical analysis is used as the baseline for determining the percentage of end use electricity consumption by main end-use appliances taking into account the particular premise features such as weather zone, type of building, building size, age, type of appliances existing and used in the given premise, fuel type used by main appliances, and number of occupants, etc.

This statistical analysis also helps to calibrate (double check the reasonableness) the amount of electricity usage calculated using the foregoing base load calculation methods described hereinabove.

The calculation of the actual consumption breakdown percentages is then

adjusted on a monthly basis to account for factors that indicate usage or lack of use or whether related appliances like electrical space heaters and air conditioning are being used, and the variation in the number of hours of daylight throughout the year is used to adjust the percentage of electricity consumption related to lights in the given premises.

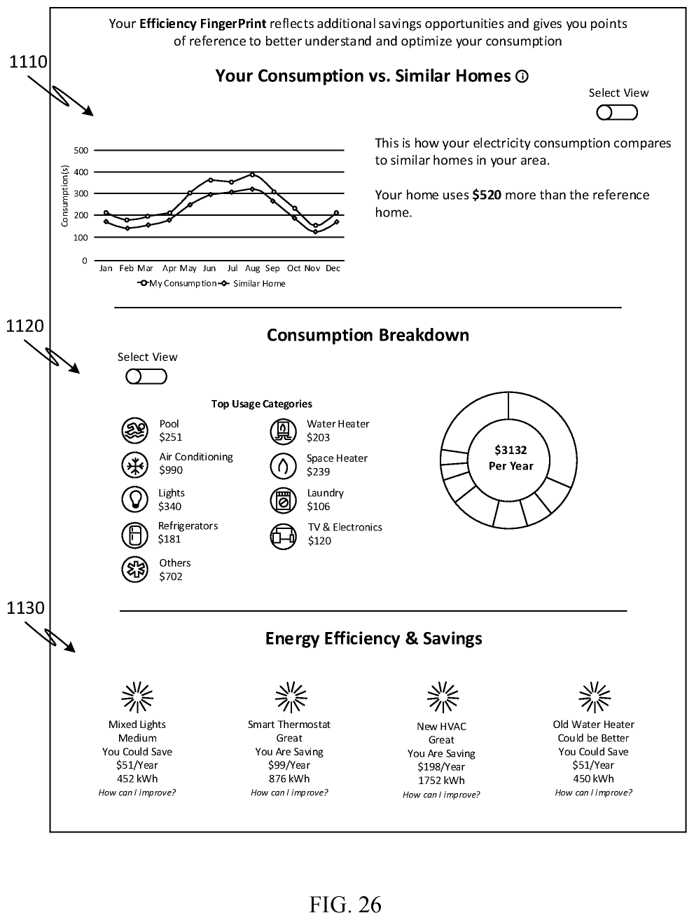

Again, FIG. 26 is a representative figure in a representative GUI format generated by the platform 100 from the analyzed data regarding the energy comparisons 1110 and energy consumption 1120 to depict calculated energy leakage 1130 and its environmental impact. Other types and formats of displays may be so generated.

FIG. 26 illustrates a representative figure in a representative GUI format generated by the platform 100 from the analyzed data regarding consumption comparisons with similar or equivalent reference buildings as well as the breakdown of consumption between the appliances and components in the building 1120 along with some narrative text explaining it.

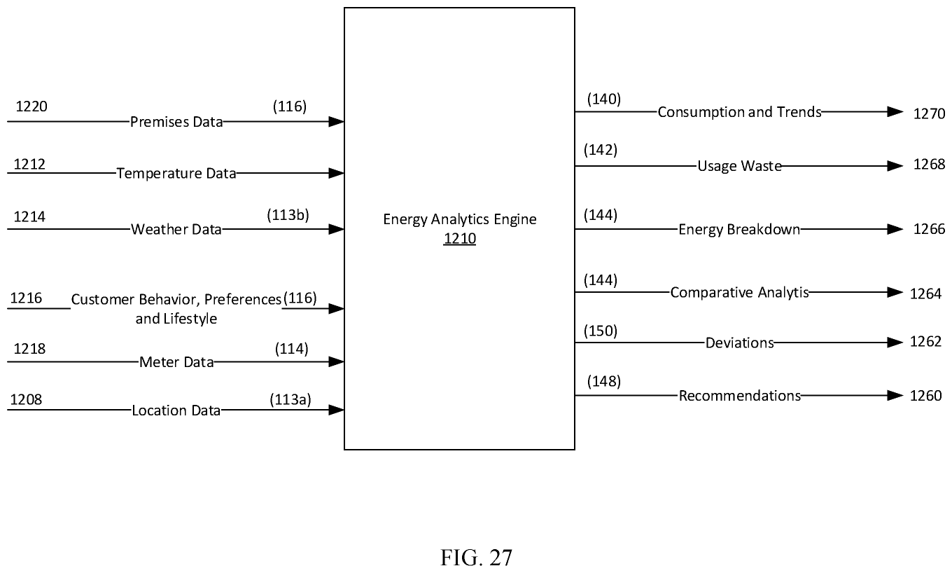

FIG. 27 illustrates in a summary manner a portion of the various inputs needed for analysis and outputs that are then supplied by the analytics engine 1210 (110) after analysis of the supplied data. These inputs and outputs have been discussed earlier herein. The inputs are for example, but not limited to premises data 1220, temperature data 1212, weather data 1214, customer behaviors 1216, preferences and lifestyle data, meter data 1218, and location data 1208. The outputs are for example, but not limited to consumption and trends 1270, leakage (waste) 1268, energy usage breakdown 1266, comparative analysis 1264, deviations 1262, and recommendations 1260. The item numbers in parentheses are the equivalent items for FIG. 7. Thus, it may be seen that the present disclosure provides a system 100 for end-user energy analytics and optimization, having at least one processor and an associated instruction memory; at least one memory storage device configured to store: (i) historical energy usage data for a premises (facility), (ii) historical weather data for the zone associated with a premises (facility), (iii) data for unique and variable premises energy characteristics, and (iv) end-user provided data regarding said premises; an analytics and computation engine executed by said at least one processor using a first portion of instructions stored in said associated instruction memory for performing: (i) conversion of and storing of historical energy usage data for a premises, (ii) statistical analysis of, aggregation of and disaggregation of said historical energy usage data, (iii) statistical analysis of historical weather data associated with historical energy usage data, (iv) machine learning and employing artificial intelligence models to identify data clustering, outliers and other data driven insights and incorporate ongoing feedback into selected types of analysis, (v) time slice synchronization of selected portions of said data stored in said at least one memory storage device, (vi) analyzing said data for energy consumption by one or more energy devices associated with said premises, (vii) computation of energy costs using said converted and stored historical energy usage data, (viii) providing alternative representations of energy usage data associated with a source of energy for said premises, and (ix) determining/providing recommendations for available energy reduction choices; a display engine executed by said at least one processor using a second portion of instructions stored in said associated instruction memory for: (i) receiving end-user goals, lifestyle behaviors, and premises information and occupation data, (ii) displaying synchronized time slice data in one or more pre-selected formats, (iii) displaying alternative representations of energy usage data associated with a source of energy for said premises, (iv) displaying recommendations for available energy reduction choices, (v) displaying energy consumption for said energy devices associated with said premises, and (vi) displaying and alerting an end-user of variances in energy use based on one or more of selected set points, excessive usage, and unintentional usage.

One representative example of a display of one portion of the results from the system is depicted in FIGS. 27-29. These examples are representative of a portion of the results that are collectively referred to as the Energy FingerPrint of the present disclosure.

The present disclosure also provides a method for the generation of an environmental impact component as part of the “Energy FingerPrint” with a matching representation of the environment impact with a calculation of possible actions needed to offset the consumer's consumption impact.

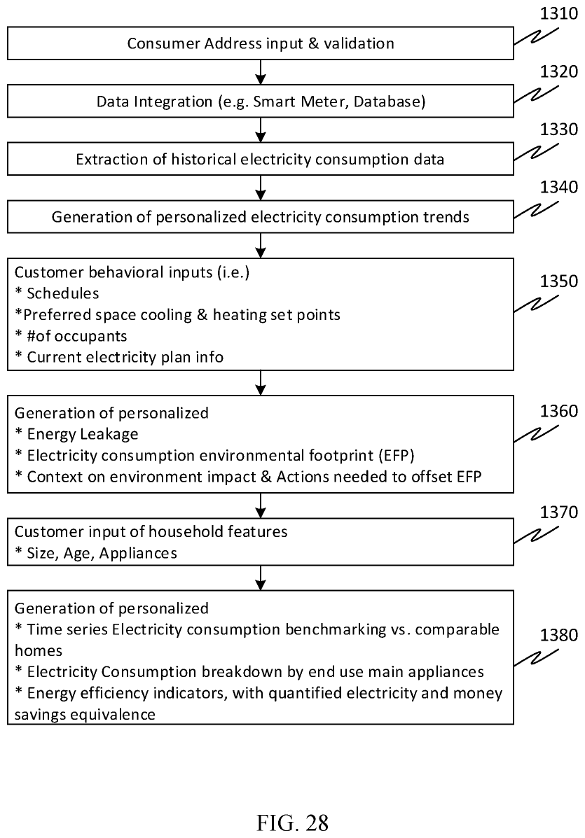

FIG. 28 illustrates the workflow and calculations and results ascertainable from the Energy FingerPrint process flow. In summary, the method of the present disclosure creates a computer implemented web-based platform with a web-based user interface (GUI) for user sign up and sign in and for enabling a user device to interface with that platform.

More particularly, the method of the present disclosure starts with a customer interfacing with the system to register and commence a customer consumption portfolio using a distinct visualization dashboard GUI, as previously depicted in FIG. 10. This initial registration enables a user to interface with the system using any user device 1310. For one embodiment, after this initial setup of an account for the customer, again with a user identification and password, and the customer authorizing the use of historical energy data for the customer's premises, then the system will automatically locate the appropriate meter usage data based on the meter number associated with the user's premises 1320. The method then extracts as much energy usage data as is available, but preferably at least 12 months of historical energy use (for example, but not limited to, smart meter data) from the appropriate meter usage database 1330. Such databases may be maintained by an individual utility, or at a state level or at a regional level by a third party.

Automated Machine Learning (AML) may be used to generate a personalized fitting of electricity consumption for each customer based on weather and other feature parameters determined by an ensemble of machine learning models. AML is the process of automating end-to-end the process of applying machine learning algorithms to real-world problems. In a typical machine learning application, a dataset consisting of input data points is used to train the models. The uncleansed data is preprocessed via extraction, selection, imputation, and application of feature set that make the dataset amenable for machine learning. Following those preprocessing steps, an algorithm selection and hyper parameter optimization is performed to maximize the predictive performance of their final machine learning model. Automating the process of applying machine learning offers the advantages of producing simpler solutions, faster creation of those solutions, and models that often outperform models that were designed by intuition.

The method of the present disclosure starts by extracting historical energy use (for example, but not limited to, smart meter data) from the appropriate meter usage database. After the time series usage data is downloaded, then the system performs multiple iterations on preloaded algorithms and optimizes the number and selection of hyper parameters. Optimization maximizes the predictive performance and can help minimize computational expense. The parameters evaluated in this process may include but are not limited to historical variations in weather factors (for example Outdoor temperature, humidity, UV index, cloudiness, etc.), premises occupancy, occupants' lifestyles and preferences including premises schedules/utilization, and appliances set points (including thermostats, water heaters, lights schedule and intensity, etc.), and premises features (for example size, thermal and insulation properties, appliances, etc.).

Once the number and optimum parameters are identified, the system runs the preloaded machine learning algorithms (including but not limited to linear regression, SVM, Ridge, Rain Forest, KNN, etc.) to generate the personalized model that best describes the electricity consumption as a function of the features and parameters selected. Normally this process is run using at least 12 months of historical electricity consumption to train and test the model to account for changes related to seasonality. With the selected parameters and input data, the machine model learning models are used to evaluate all the data sets. This typically results in several algorithms being selected as providing the best results for all the data sets and may result in additional parameters as being identified to be applied to the modeling. Best results are typically determined using a least squares regression for the various models. When 12 months of historical electricity consumption is not available, the process utilizes the data available to generate a model that will have the lowest degree of uncertainty and potentially highest prediction accuracy. To account for this increased uncertainty and potentially greater variations, the mean and standard deviation for the model generated with the known data are calculated and used to project “an acceptable working envelope/boundary” for the values generated by the predictive model.

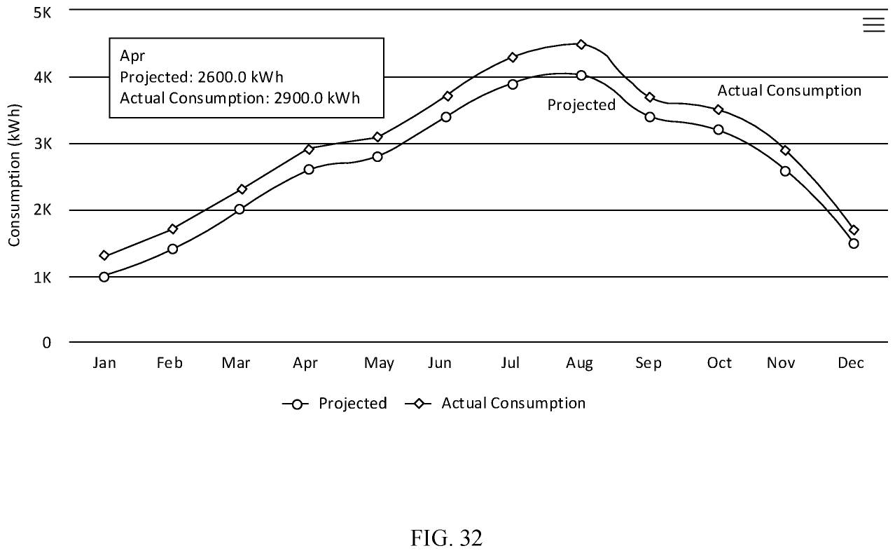

The resulting personalized model 1340 has many uses including but not limited to the projection of the annual baseline electricity consumption FIG. 32, but especially when only partial or incomplete information is available. As time goes by and additional electricity consumption data becomes available, the model is recalibrated replacing the projected given data with the newly available actual data. As the process continues, the model uncertainty decreases progressively over time, and the prediction accuracy increases. Another use of this personalized model includes the forecast of energy consumption to evaluate actual consumption values and perform prescriptive and diagnostics analytics to determine if actual usage falls within an “expected” range within x number of standard deviations (sigma) or if an alarm needs to be triggered or further evaluation performed.

After the usage data is downloaded then the system performs disaggregation and aggregation on this data and the data is also converted into a unique and specific database format and stored by the system. The method next uses this disaggregated and aggregated data in specific combinations and summaries to generate personalized energy consumption trends 1340. Examples of these types of trends were previously depicted in FIGS. 4, 5, and 6.

Continuing to refer to FIG. 28, the method also solicits from the selected customer behavioral inputs 1350 that are unique to their household, such as for example, but not limited to time schedules, number of occupants, interior temperature set points for heating and cooling, current electricity provider and plan, number of occupants and activities within the household, and usage of electrical appliances and devices, etc. FIG. 11 is one representative example of a GUI for obtaining this information from a customer.

Following this, the method may next generate personalized energy consumption 1360 based on customer behavioral inputs above that leads to additional analysis and results in personalized energy consumption such as for example, but not limited to a unique consumer calculation characteristic coined “energy leakage” representing inadvertently used electricity during periods in which the customer is not present, a determination of a unique energy consumer environmental impact component of the Energy FingerPrint, a representation of the consumer's environmental impact through a simple determination of the number of trees saved or needed to offset the CEI (consumer environmental impact).

Following this, the method may next solicit from the customer additional inputs 1370 related to the household's attributes such as for example, but not limited to size and age, installed appliances, current provider and electricity plan, etc. FIG. 12 is one representative example of a GUI for obtaining this information from a customer.

Following this additional data input, the method may next generate personalized and customizable actionable information 1380 such as, for example, but not limited to visualization of time-series usage data for comparison against localized and regional locations (benchmarking), unique energy usage breakdown by appliances (interior and exterior), unique energy efficiency indicators for cost savings, energy reduction, and consequently the environmental impact savings by the consumer. Again, FIG. 32 illustrates the predictive nature of some of the results of this method.

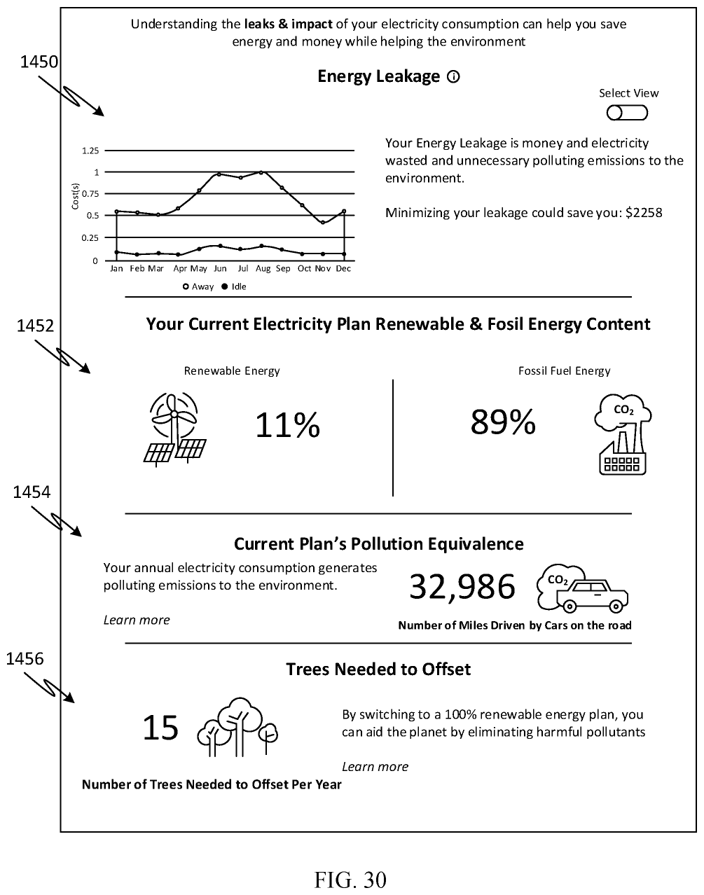

Again, FIG. 28 is a simplified block diagram depicting the main steps for a method of the present disclosure that may be implemented by the components of the system of FIG. 7. As depicted in FIG. 28, the present disclosure also provides a method 1300 for generating personalized energy analytics comprising the integration of at least 12 months of historical electricity consumption in a data series (for example, but not limited to sampled at 15 minutes intervals) for a given premises (residential, commercial or industrial), with behavioral aspects, lifestyle behaviors and preferences including schedules, number of occupants, preferred heating and cooling settings, locational, and weather related information to create a personalized multidimensional overlay to more accurately model the unique energy consumption in such given premises and its dependency with variations over time in lifestyle, behaviors, preferences and premise features and appliances. The method of the present disclosure uses a multidimensional model that includes the integration of multiple functions related to or detailing or dealing with energy consumption, all with variations over or in time, but aligned with each other along common time slices. The components of the energy analytics, as depicted in FIGS. 8 and 9, may include, but are not limited to:
Electricity consumption over time (and energy generation using solar panels, batteries, etc.) 210
Lifestyle behaviors over time (schedules, number of occupants, etc.) 218
Preference variations over time (heating and cooling set points, hot water heater set point, cost reductions, windows, insulation, etc.) 218
Building/premises feature efficiency over time (new A/C unit, new lights, aging appliances, maintenance, etc.) 218
Location specific variations over time (outdoor temperatures, weather, etc.) 218
The personalized analytics in the so-called “Energy FingerPrint” 1390 of a user provide a comprehensive model intended to provide actionable insights to help end-use energy consumers understand their energy consumption, identify saving opportunities and make smarter energy delivery and consumption choices. FIGS. 30-32 illustrate the types of information that may be selected and displayed by a customer once the “Energy FingerPrint” 1390 is calculated. It includes quantified energy consumption and savings in terms of kWh, equivalent cost and environmental impact.

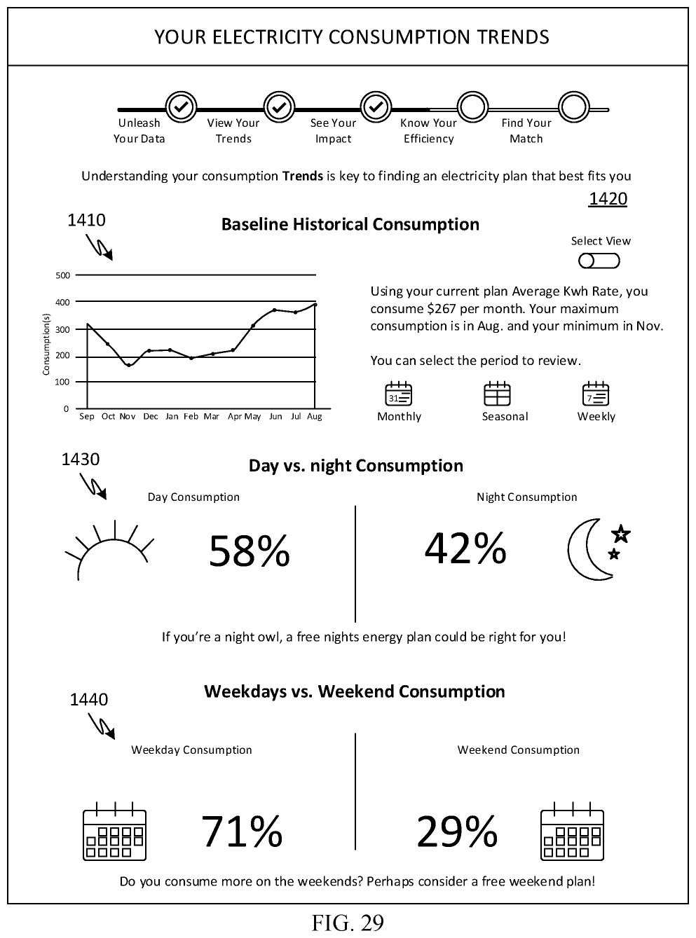

FIG. 29 is a representative figure in a representative GUI format 1420 generated by the platform 100 from electricity consumption trends. The GUI shows baseline historical consumption 1410, day vs. night consumption 1430, weekdays vs. weekend consumption 1440.

FIG. 30 is a representative figure in a representative GUI format generated by the platform 100 for the leaks and impact of electricity consumption. The GUI shows energy leakage 1450, your current electricity plan's renewable and fossil energy content 1452, current plan's pollution equivalence 1454 and trees needed to offset 1456.

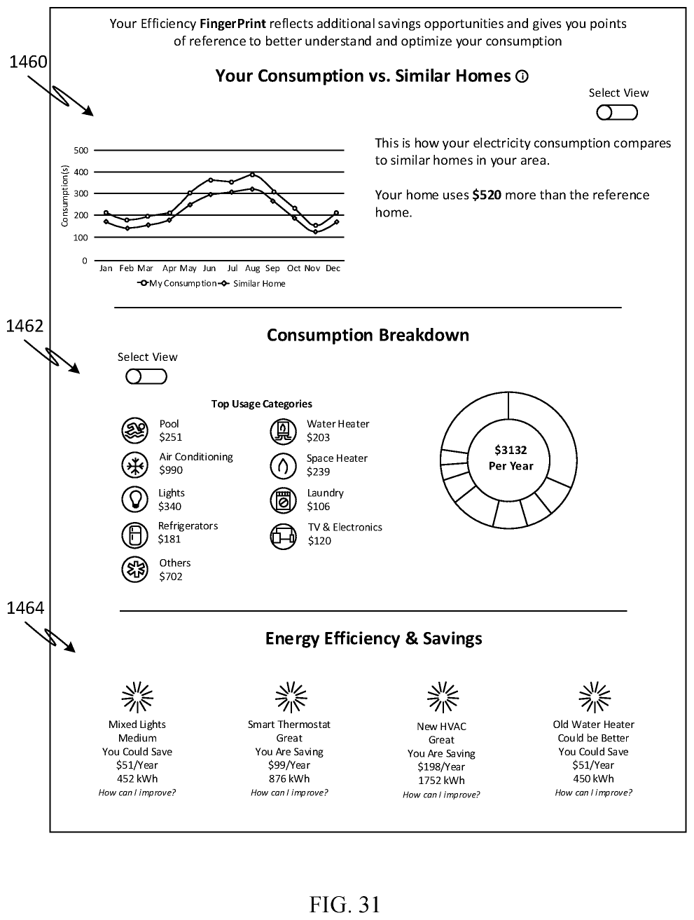

FIG. 31 is a representative figure in a representative GUI format generated by the platform 100 for the leaks and impact of electricity consumption. The GUI shows your consumption vs. similar homes 1460, consumption breakdown 1462 and energy efficiency and savings 1464.

The components of these personalized energy analytics may include, but are not limited to the following key performance indicators (KPIs):
Historical energy consumption trends 230a (140) that vary over time organized and aggregated by:
   Monthly, seasonal & weekly Consumption
   Breakdown of Day vs Night consumption
   Breakdown of Week Vs Weekend consumption
   Grid On-peak versus Off-peak consumption
Energy leakage 230b (142) defined as unintendedly consumed electricity during time periods in which there are no occupants in the given premises (away) for a baseload compared to the electricity consumed during times in which premises occupants are not actively using electricity (e.g., sleeping periods, a.k.a. Idle time)
Quantification of polluting emissions to the environment (e.g., carbon dioxide, sulfur dioxide, nitrogen oxides, methane, etc.) as a result of electricity consumption given the renewable content provided in the currently utilized electricity plan
   User friendly visualization and contextualization of the environmental implications of the emissions in every-day life terms to facilitate user understanding. For example, Greenhouse effect, Climate change, Particulates in the atmosphere, Equivalence in vehicle driving miles, Equivalence of the number of trees required to be planted to offset such environmental footprint if a switch to a 100% renewable plan is unsuitable etc.
Benchmarking of electricity consumption 230d (146) based on integrated multivariable time series data sets for comparable premises for a pre-processed sampling rate (for example, but not limited to, being sampled at variable periodic intervals, fixed 15-minute intervals and stored in a memory, being measured and stored in real time, or being sampled in near real time). Comparing electricity consumption of the given premises compared to the electricity consumption of reference premises using the pre-processed sampling rate, and with the reference premises having equivalent characteristics such as, for example, but not limited to the same weather for an area of interest, similar building size, age, fuel type used by main appliances, and number of occupants.
Total energy consumption 230c (144) breakdown by main end-use appliances in a premise
Energy Efficiency (148) indicators based on features such as, for example, but not limited to the type of light bulbs used, age of appliances, use of smart learning thermostats, use of smart or IoT appliances or devices, etc.
Thus, it may be seen that the method of the present disclosure provides a user with, for example, but not limited to the following KPI information:
Consumption Statistics
   Monthly Consumption
   Day vs Night consumption
   Week vs Weekend consumption
   Seasonal Consumption
Carbon Footprint of current plan and possible actions to offset it
Energy Leakage
   Idle vs Away consumption comparison
   Idle vs Away Seasonal Indexes
Efficiency Factor defined as:
   Efficiency indicators including but not limited to LED lights usage, Age of appliances, Heating and Cooling Temperature Vs National Average Cooling set points, Use of smart learning thermostats
Comparative premises energy consumption analysis
   Monthly consumption vs reference building consumption
Consumption Breakdown by end-use appliance

According to some embodiments, the present disclosure provides a computer implemented method for end-user energy analytics and optimization, that includes,

storing in at least one memory storage device, at least one or more of the following: historical energy usage data for a premises (facility), historical weather data for the area (zone) associated with said premises (facility), data for unique and variable

premises energy characteristics, data regarding selected energy goals for said premises, and end-user provided data regarding said premises,

using at least one processor having instructions stored in at least one instruction memory, wherein said at least one processor is configured to implement an analytics and computation engine using a first portion of instructions stored in said associated instruction memory for performing at least one or more of the following: receiving and performing statistical analysis of, aggregation of and disaggregation of said historical energy usage data,

statistically analyzing historical weather data associated with historical energy usage data,

using machine learning and employing artificial intelligence models to identify data clustering, outliers and other data driven insights and incorporate ongoing feedback to the analysis of said historical energy usage data,

converting and storing said historical energy usage data and computing energy costs based thereon,

synchronizing selected portions of said data stored in said at least one memory storage device using common time slice information,

analyzing said data for energy consumption by one or more energy devices associated with said premises, determining/providing recommendations for available energy reduction choices, and

using said at least one processor to execute a display engine using a second portion of instructions stored in said associated instruction memory for displaying and performing one or more of the following receiving end-user goals, criteria for energy consumption plans and premises occupation data,

displaying synchronized time slice data in one or more pre-selected formats, displaying alternative representations of energy usage data associated with a source of energy for said premises, displaying recommendations for available energy reduction choices,

displaying historical energy consumption for said energy devices associated with said premises.

Aspects of the present disclosure:

Aspect 1. A system (100) for end-user energy analytics and optimization, comprising: a processor (120),

a first memory (122) for storing programming instructions for the processor, wherein a first set of programming instructions when executed by the processor cause the processor to receive, convert and store in a single common interoperable data format preselected data from multiple sources regarding a plurality of customer premises, and wherein a second set of programming instructions when executed by the processor cause the processor to partition historical data, aggregate, compare and analyze said data using at least common time period and slice information for each premises of the plurality of premises,

a second memory (122) for separately storing the preselected data from multiple sources that comprises historical energy usage data (114) for a preselected location for a premises, historical weather data (113b) for preselected locations, data for a plurality of customer premises at the preselected locations (113c), and user preference and schedule data (116) for respective premises in the plurality of customer premises, and

a user interface (130) for displaying results in a plurality of preselected formats (140-148) from said processor processing said preselected data and analysis of the preselected data stored in said memories and from comparisons and combinations of those sets of data in common time periods, wherein the results comprise at least one of the following:

comparisons of energy usage in the same time period during different times (140), comparisons of energy usage in adjacent time periods (140), alternative representations of energy consumption for a preselected time period (140), energy consumption for preselected energy consumption devices for a preselected time period (144), determination of unintended energy consumption (142), efficiency of energy consumption (146), comparisons of energy usage for similar premises at the preselected locations for preselected time periods (144), and recommendations for reduction in energy consumption (148), and recommendations for adjustment in preference and schedule data for a user to control and reduce energy consumption and environmental impact (148).

Aspect 2. A system for end-user energy analytics and optimization, comprising:

at least one processor and an associated instruction memory containing energy analysis logic for execution by said at least one processor, wherein said energy analysis logic generates a multidimensional model comprised of the storage, analysis, integration and time alignment of historical electricity consumption for a premises, user lifestyle behavior variations for a premises, user preference variations for a premises, building feature efficiency variations for a premises, weather variations at a specific location where a premises is located, and outdoor temperature variations at that specific location,

at least one memory storage device configured to store, at least said multidimensional model, intermediary calculations, analysis and comparisons and data for an end-user premises, historical weather and temperatures for said premises location, historical energy usage, end-user preferences, end-user lifestyle information and schedules, and

a graphical user interface for selectively displaying representations of portions of said multidimensional model to a user in user selected formats for recommendations for adjustment in preference and schedule data for a user to reduce energy usage and environmental impact.

Aspect 3. A system for end-user energy analytics and optimization for a user premises, comprising:

at least one processor and an associated instruction memory, for storing, using and analyzing data from

a database configured to store historical weather and temperatures,

a database configured to store historical energy usage,

a database configured to store location data,

a database configured to store end-user preferences,

a database configured to store end-user lifestyle information and schedules, and

a database configured to store end-user premises information, to perform analysis of said data from said databases to construct a multidimensional energy model representative of said analysis of said data in said databases for the user premises, and

a graphical user interface for selectively displaying representations of portions of said multidimensional model to a user in user selected formats for recommendations for adjustment in preference and schedule data for a user to reduce energy usage and environmental impact.

Aspect 4. An energy analysis control system, comprising:

a processor, a communication interface coupled to the processor, and a memory coupled to the processor, wherein the memory contains energy analysis logic that is executed by the processor to create an energy analysis system, wherein said energy analysis system communicates to obtain energy usage data, other dynamic data related to energy usage by a user premises, and dynamic user information related to the user's consumption of energy at a premises in order to produce personalized analysis results as a multidimensional energy model representative of said analysis of said data for a premises, and generate and display on a user interface selective portions of the analysis results, and wherein said results of the analysis may be ranked for further review and action by the user using a graphical user interface for selectively displaying representations of portions of said multidimensional model to a user in user selected formats for recommendations for adjustment in preference and schedule data for a user to reduce energy usage and environmental impact.

Aspect 5. A system 100 for end-user energy analytics and optimization, comprising:

at least one processor 120 and an associated instruction memory 122, at least one memory storage device 122 configured to store,
(i) historical energy usage data for a premise 114,
(ii) historical weather data for the location associated with a premises 112,
(iii) data for unique and variable premises energy characteristics,
(iv) data regarding user selected energy goals for said premises 116,
(v) data regarding said premises 116 provided by the end-user, an analytics and computation engine 110 executed by said at least one processor using a first portion of programming
(i) statistical analysis of, aggregation of and disaggregation of said historical energy usage data,
(ii) statistical analysis of historical weather data associated with historical energy usage data,
(iii) machine learning and employing artificial intelligence models to identify data clustering, outliers and other data driven insights and provide feedback and input to selected portions of and types of analysis,
(iv) conditioning, conversion of and storage of said historical energy usage data,
(v) time slice synchronization of selected portions of said data stored in said at least one memory storage device,
(vi) analyzing said data for energy consumption by one or more energy devices associated with said premises,
(vii) computation of energy costs using said converted and stored historical energy usage data,
(viii) providing alternative representations of energy usage data associated with a source of energy for said premises,
(ix) determining/providing recommendations for available energy reduction choices, a display engine 130 executed by said at least one processor using a second portion of programming instructions stored in said associated instruction memory for generating a graphical user interface for
   (i) receiving end-user goals, criteria for energy consumption plans and premises occupation data,
   (ii) displaying synchronized time slice data in one or more pre-selected formats,
   (iii) displaying alternative representations of energy usage data associated with a source of energy for said premises,
   (iv) displaying alternative representations of environmental impact associated with the energy consumption and the source of energy for said premises
   (v) displaying recommendations for available energy reduction choices,
   (vi) displaying recommendations and alternative representations for available environmental impact reduction choices,
   (vii) displaying energy consumption for said energy devices associated with said premises,
   (viii) displaying and alerting an end-user of variances in energy use based on one or more of selected set points, excessive usage, and unintentional usage.

Aspect 6. A system for determining end-user energy leakage in a residence, comprising: a memory for storing a set of data for historical energy usage data, a set of data for historical weather data, and a set of users provided data for residence information, a memory for storing a set of data for user preference and schedule data,

a processor, a memory for storing instructions for the processor such that when said instructions are executed by the processor cause the processor to partition the historical sets of data into a preselected database format, calculate energy usage for time periods determined from user preference and schedule data and historical weather data, aggregate, process and analyze data using at least common time slice information, and employing machine learning models to calculate and determine away and idle energy consumption, and a user interface for displaying results in a plurality of preselected formats from said processor processing said data and analysis of the sets of data stored in said memories and from comparisons and combinations of these sets of data.

Aspect 7. A computer implemented method for determining end-user energy leakage comprising:

storing in at least one memory storage device, at least one or more of the following: historical energy usage data for a premise, historical weather data for the area (zone) associated with said premises, data for unique and variable premises energy characteristics, data regarding selected energy goals for said premises; and end-user provided data regarding said premises, the occupants schedules that might reflect or serve to infer idle times using a first portion of programming instructions stored in an instruction memory for implementing an analytics and computation engine for performing at least one or more of the following:

receiving and performing statistical analysis of, aggregation of and disaggregation of said historical energy usage data, converting and storing said historical energy usage data,

statistically analyzing historical weather data associated with historical energy usage data and user, to identify data trends, correlations, clustering, outliers and other data driven insights and incorporating ongoing feedback to the analysis of said historical energy usage data accounting for locational and weather factors using time period and time slice information,

synchronizing selected portions of said data stored in said at least one memory storage device using common time slice information,

analyzing said data for energy consumption during away, idle and non-idle periods associated with said premises,

computing energy leakage, its associated cost and environmental impact, using said converted and stored historical energy usage data comparing the energy usage of said premise during idle and away periods,

providing alternative representations of energy usage during away, idle, non-idle periods, and energy leakage data associated with a source of energy for said premises,

providing alternative representations of the associated cost and environmental impact of the energy usage during away, idle, non-idle periods, and energy leakage data associated with said premises,

determining/providing recommendations for available energy leakage reduction choices, and

using a second portion of instructions stored in said instruction memory for displaying and performing one or more of the following:

receiving end-user inputs (e.g., goals, preferences, lifestyle, appliances settings), premises features and occupation data,

displaying synchronized time slice data in one or more pre-selected formats, displaying alternative representations of energy usage and energy leak, cost and environmental impact data associated with a source of energy for said premises,

displaying recommendations for available energy leakage reduction choices for example adjustment of set points and appliances operating schedules during away and idle times for said premises.

Aspect 8. A computer implemented system for determining consumption of energy by equipment and appliances in a user residence comprising:

a memory for storing a set of data for historical energy usage data, a set of data for historical weather data, a set of data for statistical energy consumption data for residence equipment and appliances, and a set of user provided data for a residence information data,

a memory for storing a set of data for user preference and schedule data, a processor,

a memory for storing programming instructions for the processor such that when said instructions are executed by the processor cause the processor to partition the historical sets of data into a preselected database format, calculate energy usage for time periods determined from user preference and schedule data and historical weather data, aggregate, process and analyze historical and statistical data using at least common time slice information, and

a user interface for displaying results in a plurality of preselected formats from said processor processing said data and analysis of the sets of data stored in said memories and from comparisons and combinations of these sets of data to provide resulting energy consumption for individual appliances and equipment in the user residence.

Aspect 9. A computer implemented method for determining consumption of energy by equipment and appliances in a user residence comprising:

storing in at least one memory storage device, at least one or more of the following: historical (e.g., time series) energy usage data for a premise (facility), historical (e.g., time series) time series weather data for the area (zone) associated with said premises (facility), data for unique and variable premises energy characteristics; and end-user provided data regarding said premises, the number of occupants, the occupants preferred indoor cooling and heating temperature, and the appliances in said premise, using a first portion of instructions stored in an instruction memory for implementing an analytics and computation engine for performing at least one or more of the following:

receiving and performing statistical analysis of, aggregation of and disaggregation of said historical energy usage data,

converting and storing said historical energy usage data,

statistically analyzing historical weather data associated with historical energy usage data and user, to identify data trends, correlations, clustering, outliers and other data driven insights and incorporating ongoing feedback to the analysis of said historical energy usage data accounting for locational and weather factors,

synchronizing selected portions of said data stored in said at least one memory storage device using common time slice information,

analyzing said data to determine weather neutral dates in which it is assumed that there is no need for using air-conditioning or heating to achieve the occupants desired indoor temperature associated with said premises, given the outdoor weather conditions for the location associated with said premises,

analyzing said data for energy consumption during Weather Neutral Dates associated with said premises,

computing the base energy consumption load for said premise, using said converted and stored historical energy usage data analyzing said data for energy consumption during the remaining dates in the time series associated with said premises,

computing the energy consumption load for said premise, during the remaining dates in the time series (e.g., Non-Weather Neutral Dates) using said converted and stored historical energy usage data comparing the energy usage of said premise during Weather Neutral Dates and Non-Weather Neutral Dates to compute the energy usage associated with air-conditioning and heating for the said premise,

computing the energy consumption load for lights in said premise, during the entire period in the time series (e.g., Weather Neutral dates and Non-Weather Neutral Dates) using said converted and stored historical physical characteristics and energy usage data for said premise, and statistical energy usage for said physical characteristics for said premise computing the energy consumption by end appliance using statistical modeling of end-appliance building electricity consumption using said converted and stored historical physical characteristics, and energy usage data for said premise adjusted for the energy usage corresponding to air conditioning, heating and lights previously computed; and statistical energy usage for said physical characteristics for said premise.

providing alternative representations of energy usage, cost and environmental impact by end use appliance associated with a source of energy for said premises,

determining/providing recommendations for available energy reduction choices, and

using a second portion of instructions stored in said instruction memory for displaying and performing one or more of the following:

receiving end-user inputs and updates (e.g., goals, preferences, lifestyle, appliances settings), premises features and occupation data,

displaying synchronized time slice data in one or more pre-selected formats,

displaying alternative representations of energy usage, cost and environmental impact data by end use appliance associated with a source of energy for said premises,

displaying recommendations for available energy usage reduction choices for example adjustment of set points and appliances operating schedules during away and idle times, changes to higher energy efficiency options for said premises.

Aspect 10. A computer implemented method for end-user energy analytics and optimization, comprising:

receiving, converting and storing in a single common interoperable data format preselected data from multiple sources in a memory,

separately storing the preselected data from multiple sources wherein the data comprises: historical energy usage data for a preselected location, historical weather data for a preselected location, data for a premise at the preselected location, and user preference and schedule data for a premises,

partitioning historical data, aggregating, comparing and analyzing said data using at least common time period (energy use cycles) and time slice information, and

displaying in a plurality of preselected formats results from said partitioned, aggregated, compared and analyzed stored data, wherein the results comprise at least one of the following:

comparing energy usage in the same time period during different times, comparing energy usage in adjacent time periods, representing energy consumption for a preselected time period in an alternative format, calculating energy for preselected energy consumption devices for a preselected time period, determining unintended energy consumption, determining efficiency of energy consumption, comparing energy usage for similar residences at the preselected location for preselected time periods, and recommending energy consumption reductions.

Aspect 11. A computer implemented method for end-user energy analytics and optimization, comprising:

receiving, converting and storing in a single common interoperable data format preselected data from multiple sources in a memory,

separately storing the preselected data from multiple sources wherein the data comprises: historical energy usage data for a preselected location, historical weather data for a preselected location, data for a premise at the preselected location, and user preference and schedule data for a premises,

using a processor having instructions stored in an instruction memory for the processor, wherein a first set of instructions when executed by the processor cause the processor to partition historical data, aggregate, compare and analyze said data using at least common time period (energy use cycles) and time slice information,

and displaying results in a user interface in a plurality of preselected formats from said processor processing said preselected data and analysis of the preselected data stored in said memories and from comparisons and combinations of those sets of data in common time periods, wherein the results comprise at least one of the following:

comparisons of energy usage in the same time period during different times, comparisons of energy usage in adjacent time periods, alternative representations of energy consumption for a preselected time period, energy consumption for preselected energy consumption devices for a preselected time period, determination of unintended energy consumption, efficiency of energy consumption, comparisons of energy usage for similar residences at the preselected location for preselected time periods, and recommendations for reduction in energy consumption.

Aspect 12. A computer implemented method for end-user energy analytics and optimization, comprising:

storing in at least one memory storage device, at least one or more of the following: historical energy usage data for a premises (facility), historical weather data for the area (zone) associated with said premises (facility), data for unique and variable premises energy characteristics, data regarding selected energy goals for said premises, and end-user provided data regarding said premises, using at least one processor having instructions stored in at least one instruction memory, wherein said at least one processor is configured to implement an analytics and computation engine using a first portion of programming instructions stored in said associated instruction memory for performing at least one or more of the following:

receiving and performing statistical analysis of, aggregation of and disaggregation of said historical energy usage data,

statistically analyzing historical weather data associated with historical energy usage data,

using machine learning and employing artificial intelligence models to identify data clustering, outliers and other data driven insights and incorporate ongoing feedback to the analysis of said historical energy usage data,

converting and storing said historical energy usage data,

synchronizing selected portions of said data stored in said at least one memory storage device using common time slice information,

analyzing said data for energy consumption by one or more energy devices associated with said premises,

computing energy costs using said converted and stored historical energy usage data,

providing alternative representations of energy usage data associated with a source of energy for said premises,

determining/providing recommendations for available energy reduction choices,

and using said at least one processor to execute a display engine using a second portion of programming instructions stored in said associated instruction memory for displaying and performing one or more of the following in a user graphical interface:

establishing interface with end-user (e.g., interactive), receiving end-user inputs (e.g., lifestyle, schedules, preferences, appliances set points, energy, environmental and costs goals), criteria for energy consumption plans and premises occupation data,

displaying synchronized time slice data in one or more pre-selected formats, displaying alternative representations of energy usage data associated with a source of energy for said premises, displaying recommendations for available energy reduction choices, displaying energy consumption for said energy devices associated with said premises, displaying, alerting an end-user of variances in energy use based on one or more of selected set points, excessive usage, and unintentional usage; prompting for at least one of questions, behavioral cues, reports, comparisons versus trends, norms, or peers, and receiving end-user feedback related to changes to inputs or premises.

Aspect 13. A computer implemented method for end-user energy analytics and optimization, comprising:

storing in at least one memory storage device, at least one or more of the following: historical energy usage data for a premises (facility), historical weather

data for the area (zone) associated with said premises (facility), data for unique and variable premises energy characteristics, data regarding selected energy goals for said premises, and end-user provided data regarding said premises, using a first portion of instructions stored in an instruction memory for implementing an analytics and computation engine for performing at least one or more of the following:

receiving and performing statistical analysis of, aggregation of and disaggregation of said historical energy usage data,

converting and storing said historical energy usage data, statistically analyzing historical weather data associated with historical energy usage data,

using machine learning and employing artificial intelligence models to identify data trends, correlations, clustering, outliers and other data driven insights and incorporating ongoing feedback to the analysis of said historical energy usage data,

synchronizing selected portions of said data stored in said at least one memory storage device using common time slice information,

analyzing said data for energy consumption by one or more energy devices associated with said premises,

computing energy costs using said converted and stored historical energy usage data,

providing alternative representations of energy usage data associated with a source of energy for said premises,

determining/providing recommendations for available energy reduction choices, and

using a second portion of instructions stored in said instruction memory for displaying and performing one or more of the following:

receiving end-user inputs (e.g., goals, preferences, lifestyle, appliances settings), premises features and occupation data,

displaying synchronized time slice data in one or more pre-selected formats,

displaying alternative representations of energy usage data associated with a source of energy for said premises,

displaying recommendations for available energy reduction choices, displaying energy consumption for said energy devices associated with said premises.

Aspect 14. A computer implemented method for analyzing and optimization energy consumption for premises of an end-user, comprising:

statistically analyzing historical energy usage data using aggregation and disaggregation methods,

statistically analyzing historical weather data associated with historical energy usage data,

using machine learning and artificial intelligence models to identify data clustering, outliers and other data driven insights and incorporate ongoing feedback to the analysis,

converting and storing said historical energy usage data in at least one memory storage device and computing energy costs using said converted and stored historical energy usage data,

synchronizing selected portions of said data stored in said at least one memory storage device using a common time slice,

analyzing said historical energy usage data for energy consumption by one or more energy devices associated with said premises,

providing alternative representations of energy usage data associated with a source of energy for a premise having said historical energy usage data, determining/providing recommendations for available energy reduction choices,

receiving end-user inputs (e.g., goals, criteria for energy consumption plans, premises features, and occupation data),

displaying synchronized time slice data in one or more pre-selected formats, displaying alternative representations of energy usage data associated with a

source of energy for said premises,

displaying alternative representations of environmental impact associated with the energy consumption and the source of energy for said premises displaying recommendations and alternative representations for available environmental impact reduction choices,

displaying recommendations for choices for available energy reduction,

displaying energy consumption for energy devices associated with said premises,

displaying and alerting an end-user of variances in energy use based on one or more of selected set points, excessive usage, and unintentional usage.

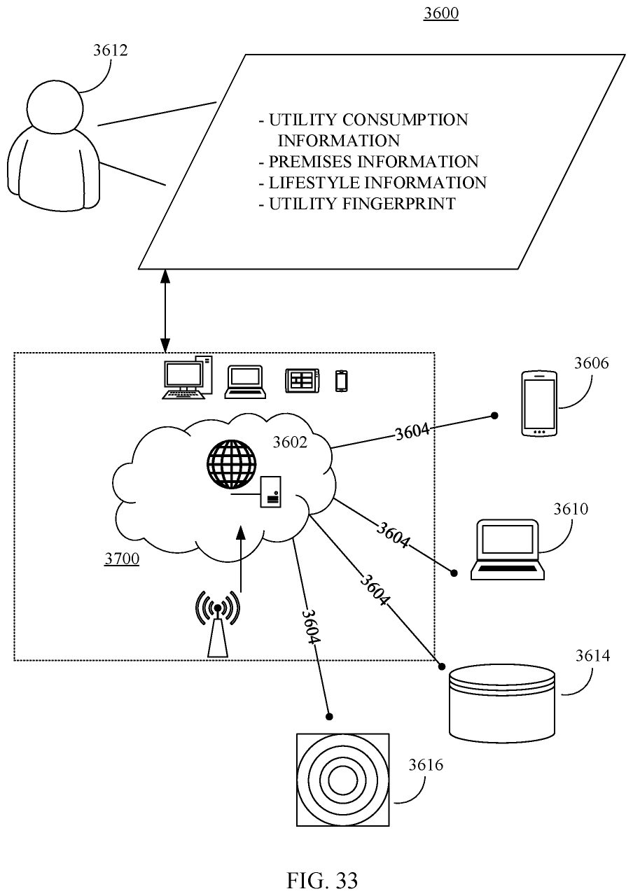

FIG. 33 is an illustration of an online platform 3600 consistent with various embodiments of the present disclosure. By way of non-limiting example, the online platform 3600 to facilitate generation at least one utility fingerprint associated with at least one premises may be hosted on a centralized server 3602, such as, for example, a cloud computing service. The centralized server 3602 may communicate with other network entities, such as, for example, a mobile device 3606 (such as a smartphone, a laptop, a tablet computer etc.), other electronic devices 3610 (such as desktop computers, server computers etc.), databases 3614, and sensors 3616 over a communication network 3604, such as, but not limited to, the Internet. Further, users of the online platform 3600 may include relevant parties such as, but not limited to, end-users, administrators, service providers, service consumers and so on. Accordingly, in some instances, electronic devices operated by the one or more relevant parties may be in communication with the platform.

A user 3612, such as the one or more relevant parties, may access online platform 100 through a web based software application or browser. The web based software application may be embodied as, for example, but not be limited to, a website, a web application, a desktop application, and a mobile application compatible with a computing device 3700.

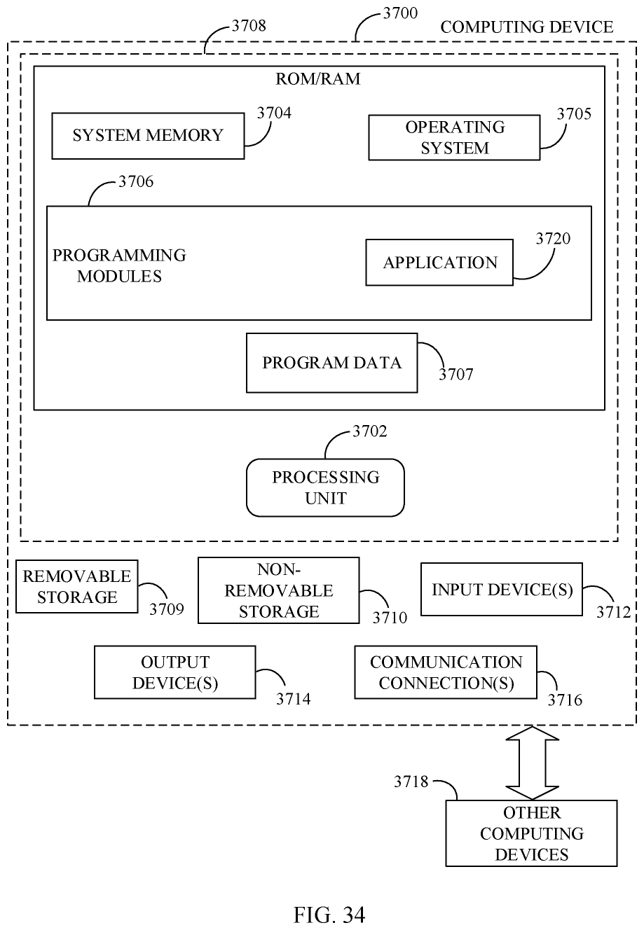

With reference to FIG. 34, a system consistent with an embodiment of the disclosure may include a computing device or cloud service, such as computing device 3700. In a basic configuration, computing device 3700 may include at least one processing unit 3702 and a system memory 3704. Depending on the configuration and type of computing device, system memory 3704 may comprise, but is not limited to, volatile (e.g. random-access memory (RAM)), non-volatile (e.g. read-only memory (ROM)), flash memory, or any combination. System memory 3704 may include operating system 3705, one or more programming modules 3706, and may include a program data 3707. Operating system 3705, for example, may be suitable for controlling computing device 3700's operation. In one embodiment, programming modules 3706 may include analysis module, machine learning module. Furthermore, embodiments of the disclosure may be practiced in conjunction with a graphics library, other operating systems, or any other application program and is not limited to any particular application or system. This basic configuration is illustrated in FIG. 34 by those components within a dashed line 3708.

Computing device 3700 may have additional features or functionality. For example, computing device 3700 may also include additional data storage devices (removable and/or non-removable) such as, for example, magnetic disks, optical disks, or tape. Such additional storage is illustrated in FIG. 34 by a removable storage 3709 and a non-removable storage 3710. Computer storage media may include volatile and non-volatile, removable and non-removable media implemented in any method or technology for storage of information, such as computer-readable instructions, data structures, program modules, or other data. System memory 3704, removable storage 3709, and non-removable storage 3710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 3700. Any such computer storage media may be part of device 3700. Computing device 3700 may also have input device(s) 3712 such as a keyboard, a mouse, a pen, a sound input device, a touch input device, a location sensor, a camera, a biometric sensor, etc. Output device(s) 3714 such as a display, speakers, a printer, etc. may also be included. The aforementioned devices are examples and others may be used.

Computing device 3700 may also contain a communication connection 3716 that may allow device 3700 to communicate with other computing devices 3718, such as over a network in a distributed computing environment, for example, an intranet or the Internet. Communication connection 3716 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 3704, including operating system 3705. While executing on processing unit 3702, programming modules 3706 (e.g., application 3720) may perform processes including, for example, one or more stages of methods, algorithms, systems, applications, servers, databases as described above. The aforementioned process is an example, and processing unit 3702 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A system for generating at least one utility fingerprint associated with at least one premises, the system comprising:
a communication device configured for:
receiving at least one utility consumption information from at least one utility consumption information source, wherein the at least one utility consumption information is associated with consumption of at least one utility corresponding to the at least one premises;
receiving at least one premises information from at least one premises information source, wherein the at least one premises information is associated with the at least one premises;
receiving at least one lifestyle information from at least one lifestyle information source, wherein the at least one lifestyle information is associated with at least one occupant of the at least one premises; and
transmitting at least one utility fingerprint associated with the at least one premises to at least one electronic device;
a processing device configured for:
analyzing each of the at least one utility consumption information, the at least one premises information and the at least one lifestyle information; and
generating the at least one utility fingerprint associated with the at least one premises based on the analyzing; and
a storage device configured for storing each of the at least one utility consumption information, the at least one premises information, the at least one lifestyle information and the at least one utility fingerprint.

2. The system of claim 1, wherein the at least one utility consumption information comprises a first utility consumption information corresponding to a first time period and a second utility consumption information corresponding to a second time period, wherein the at least one lifestyle information comprises a first lifestyle information associated with the first time period and a second lifestyle information associated with the second time period, wherein the second time period is later than the first time period, wherein the analyzing comprises:
determining a utility consumption variation based on comparing the first utility consumption information and the second utility consumption information; and
determining a lifestyle variation based on comparing the first lifestyle information and the second lifestyle information, wherein the at least one utility fingerprint comprises each of the utility consumption variation and the lifestyle variation.

3. The system of claim 1, wherein the at least one premises information comprises at least one efficiency indicator associated with the at least one utility consuming appliance deployed in the at least one premises, wherein the at least one efficiency indicator comprises a first efficiency indicator corresponding to a first time period and a second efficiency indicator corresponding to a second time period, wherein the second time period is later than the first time period, wherein the analyzing comprises determining an efficiency variation based on comparing the first efficiency indicator and the second efficiency indicator, wherein the at least one utility fingerprint comprises the efficiency variation.

4. The system of claim 1, wherein the communication device is further configured for receiving at least one environmental information from at least one environmental information source, wherein the at least one environmental information is associated with the at least one premises.

5. The system of claim 4, wherein the at least one premises information comprises a premises identifier associated with a premises of the at least one premises, wherein the analyzing comprises:
identifying a premises information associated with the premises;
performing a first comparison of the premises information with a plurality of premises information;
performing a second comparison of a lifestyle information associated with the premises with a plurality of lifestyle information;
performing a third comparison of an environmental information associated with the premises with a plurality of environmental information;
determining a reference premises information based on each of the first comparison, the second comparison and the third comparison;
determining a reference utility consumption information associated with the reference premises, wherein a utility fingerprint associated with the premises comprises each of the reference premises information and the reference utility consumption information.

6. The system of claim 4, wherein the at least one utility consumption information corresponds to at least one total utility consumption associated with at least one environment conditioning appliance and at least one non-environment conditioning appliance disposed in the at least one premises, wherein the analyzing comprises:
comparing the at least one lifestyle information and an outdoor environmental information comprised in the at least one environmental information;
identifying at least one weather-neutral time period and at least one non-weather-neutral time period based on the comparing;
determining at least one baseline utility consumption information associated with the at least one weather-neutral time period;
determining at least one environment conditioning utility consumption information corresponding to consumption of the at least one utility by the at least one environment conditioning appliance based on each of the at least one total utility consumption and the at least one baseline utility consumption, wherein the at least one utility fingerprint comprises the at least one environment conditioning utility consumption information.

7. The system of claim 6, wherein the at least one premises information comprises at least one premises utility consumption model comprising at least one premises characteristic associated with a premises, at least one utility consuming appliance associated with the premises and at least one estimated utility consumption information associated with the at least one utility consuming appliance, wherein the analyzing further comprises determining at least one lighting utility consumption information corresponding to consumption of the at least one utility by at least one lighting appliance based on the at least one premises utility consumption model, wherein the at least one utility fingerprint comprises the at least one lighting utility consumption information.

8. The system of claim 7, wherein the analyzing further comprises determining at least one end-appliance utility consumption information associated with at least one end appliance based on each of the at least one total utility consumption, the at least one environment conditioning utility consumption information and the at least one lighting utility consumption information, wherein the at least one utility fingerprint comprises the at least one end-appliance utility consumption information.

9. The system of claim 1, wherein the at least one utility fingerprint comprises a utility leakage, wherein the analyzing comprises:
determining at least one non-usage period based on the at least one lifestyle information, wherein the at least one lifestyle information corresponds to at least one activity performable in the at least one premises by the at least one occupant and at least one-time period associated with the at least one activity; and
determining the utility leakage corresponding to the at least one non-usage period based on a utility consumption information associated with the at least one non-usage period.

10. The system of claim 9, wherein the generating of the at least one utility fingerprint comprises generating an environmental impact information based on at least one of the utility leakage and the at least one utility consumption information, wherein the at least one utility fingerprint comprises the environmental impact information.

11. A method of generating at least one utility fingerprint associated with at least one premises, the method comprising:
receiving, using a communication device, at least one utility consumption information from at least one utility consumption information source, wherein the at least one utility consumption information is associated with consumption of at least one utility corresponding to the at least one premises;
receiving, using the communication device, at least one premises information from at least one premises information source, wherein the at least one premises information is associated with the at least one premises;
receiving, using the communication device, at least one lifestyle information from at least one lifestyle information source, wherein the at least one lifestyle information is associated with at least one occupant of the at least one premises;
analyzing, using a processing device, each of the at least one utility consumption information, the at least one premises information and the at least one lifestyle information;
generating, using the processing device, the at least one utility fingerprint associated with the at least one premises based on the analyzing;
transmitting, using the communication device, the at least one utility fingerprint associated with the at least one premises to at least one electronic device; and
storing, using a storage device, each of the at least one utility consumption information, the at least one premises information, the at least one lifestyle information and the at least one utility fingerprint.

12. The method of claim 11, wherein the at least one utility consumption information comprises a first utility consumption information corresponding to a first time period and a second utility consumption information corresponding to a second time period, wherein the at least one lifestyle information comprises a first lifestyle information associated with the first time period and a second lifestyle information associated with the second time period, wherein the second time period is later than the first time period, wherein the analyzing comprises:
determining a utility consumption variation based on comparing the first utility consumption information and the second utility consumption information; and
determining a lifestyle variation based on comparing the first lifestyle information and the second lifestyle information, wherein the at least one utility fingerprint comprises each of the utility consumption variation and the lifestyle variation.

13. The method of claim 11, wherein the at least one premises information comprises at least one efficiency indicator associated with the at least one utility consuming appliance deployed in the at least one premises, wherein the at least one efficiency indicator comprises a first efficiency indicator corresponding to a first time period and a second efficiency indicator corresponding to a second time period, wherein the second time period is later than the first time period, wherein the analyzing comprises determining an efficiency variation based on comparing the first efficiency indicator and the second efficiency indicator, wherein the at least one utility fingerprint comprises the efficiency variation.

14. The method of claim 11 further comprising receiving, using the communication device, at least one environmental information from at least one environmental information source, wherein the at least one environmental information is associated with the at least one premises.

15. The method of claim 14, wherein the at least one premises information comprises a premises identifier associated with a premises of the at least one premises, wherein the analyzing comprises:
identifying a premises information associated with the premises;
performing a first comparison of the premises information with a plurality of premises information;
performing a second comparison of a lifestyle information associated with the premises with a plurality of lifestyle information;
performing a third comparison of an environmental information associated with the premises with a plurality of environmental information;
determining a reference premises information based on each of the first comparison, the second comparison and the third comparison;
determining a reference utility consumption information associated with the reference premises, wherein a utility fingerprint associated with the premises comprises each of the reference premises information and the reference utility consumption information.

16. The method of claim 14, wherein the at least one utility consumption information corresponds to at least one total utility consumption associated with at least one environment conditioning appliance and at least one non-environment conditioning appliance disposed in the at least one premises, wherein the analyzing comprises:
comparing the at least one lifestyle information and an outdoor environmental information comprised in the at least one environmental information;
identifying at least one weather-neutral time period and at least one non-weather-neutral time period based on the comparing;
determining at least one baseline utility consumption information associated with the at least one weather-neutral time period;
determining at least one environment conditioning utility consumption information corresponding to consumption of the at least one utility by the at least one environment conditioning appliance based on each of the at least one total utility consumption and the at least one baseline utility consumption, wherein the at least one utility fingerprint comprises the at least one environment conditioning utility consumption information.

17. The method of claim 16, wherein the at least one premises information comprises at least one premises utility consumption model comprising at least one premises characteristic associated with a premises, at least one utility consuming appliance associated with the premises and at least one estimated utility consumption information associated with the at least one utility consuming appliance, wherein the analyzing further comprises determining at least one lighting utility consumption information corresponding to consumption of the at least one utility by at least one lighting appliance based on the at least one premises utility consumption model, wherein the at least one utility fingerprint comprises the at least one lighting utility consumption information.

18. The method of claim 17, wherein the analyzing further comprises determining at least one end-appliance utility consumption information associated with at least one end appliance based on each of the at least one total utility consumption, the at least one environment conditioning utility consumption information and the at least one lighting utility consumption information, wherein the at least one utility fingerprint comprises the at least one end-appliance utility consumption information.

19. The method of claim 11, wherein the at least one utility fingerprint comprises a utility leakage, wherein the analyzing comprises:
determining at least one non-usage period based on the at least one lifestyle information, wherein the at least one lifestyle information corresponds to at least one activity performable in the at least one premises by the at least one occupant and at least one-time period associated with the at least one activity; and
determining the utility leakage corresponding to the at least one non-usage period based on a utility consumption information associated with the at least one non-usage period.

20. The method of claim 19, wherein the generating of the at least one utility fingerprint comprises generating an environmental impact information based on at least one of the utility leakage and the at least one utility consumption information, wherein the at least one utility fingerprint comprises the environmental impact information.
